(19) United States
(12) Patent Application Publication
(10) Pub. No.: US 2007/0200846 A1
(43) Pub. Date: Aug. 30, 2007

(54) Object Display Device And Object Display Program

(75) Inventor: Masahiro Nakamura, Tottori (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: LEXER RESEARCH INC., Tottori-shi (JP)

(21) Appl. No.: 10/594,975

(22) PCT Filed: Mar. 25, 2005
(86) PCT No.: PCT/JP05/05546

§ 371 Date: Sep. 29, 2006

(30) Foreign Application Priority Data
Mar. 30, 2004 (JP) 2004-100827

(51) Int. Cl. G06T 15/00

(52) U.S. Cl. 345/419

(57) ABSTRACT

There is provided a display device, with regard to a product existing in a real space and being assembled by a plurality of components, capable of displaying the component as component object in a virtual space and of displaying an in-process product on an in-process stage of the product by using the component objects, the display device comprising: object selection means for selecting a component object to be displayed in the virtual space out of the component objects constituting the in-process product object, based on assembly procedure data showing an assembly procedure of the product; and object display means for displaying the component object selected by the object selection means as a selected component object.

### TECHNICAL FIELD

The present invention relates to a display device, with regard to a product existing in a real space and being assembled by a plurality of components, capable of displaying the component as component object in a virtual space and of displaying an in-process product on an in-process stage of the product by using the component objects, and a program for causing the device to perform a prescribed operation.

### BACKGROUND ART

In recent years, in a VR (Virtual Reality) system, various high-speed drawing technologies are provided for speeding-up a drawing processing of an object displayed in the virtual space. As a typical high-speed drawing technology, there are given examples such as occlusion culling (method of not including data of the object concealed behind other object in display data), view frustum culling (method of shortening a display time by not including data of the object that is out of a visual field in display data), and LOD (Level Of Detail, method of displaying the object by switching the number of polygon according to a distance from a visual point), and a technology is suitably adopted by the kind of the object to be displayed in the virtual space.

However, the conventional occlusion culling involves a problem such that as a shape of the object to be displayed in the virtual space becomes complicated or as the number of objects to be displayed is increased, a longer period of time is required for culling processing.

Also, there is a problem such that although the high-speed drawing technology is suitably adopted in accordance with the kind of the object to be displayed in the virtual space, an advantage obtained is different by each technology, and therefore it is difficult to anticipate an effect of an improvement in a regular performance as a device.

As described above, the conventional technology involves problems such that a desired high-speed drawing processing effect cannot be obtained under an influence of the shape of the object itself or the number of the objects to be displayed in the virtual space, and that a stable high-speed drawing processing effect as a device cannot be obtained.

### DISCLOSURE OF THE INVENTION

In order to solve the above-described problem, the present invention provides the following means.

Specifically, an object display device of the present invention provides a display device, with regard to a product existing in a real space and being assembled by a plurality of components, capable of displaying the component as component object in a virtual space and of displaying an in-process product on an in-process stage of the product by using the component objects, the display device comprising: object selection means for selecting a component object to be displayed in the virtual space out of the component objects constituting the in-process product object, based on assembly procedure data showing an assembly procedure of the product; and object display means for displaying the component object selected by the object selection means as a selected component object.

According to this structure, the object selection means selects the component object to be displayed based on the assembly procedure data showing the assembling procedure of the product. Therefore, without requiring culling processing based on three-dimensional positional relation calculation required for performing a three-dimensional display of the component object as is conventionally done, an overlapped portion of the component objects is effectively processed as needed, and the in-process product object, etc., can be displayed at a high speed. In addition, without being affected by the shape of the object itself and the number of the objects to be displayed in the virtual space, a stable performance as a device can be secured. Particularly, by assembling a plurality of components, when the in-process product in a massive state (agglomerated state) housing a plurality of components is displayed as an in-process product object, the effect becomes remarkable. In addition, the assembly procedure data is set as static data, and for example, if the setting is suitably changed, a desired component object can be easily displayed in the virtual space.

Namely, high-speed drawing processing can be obtained, a stable performance as a device can be exerted, and further, an object display device having high performance can be provided.

Moreover, when the assembly procedure data has role relation data showing a role relation between components, the role relation between components in the real space can be effectively reflected on the role relation of the component object displayed in the virtual space. Therefore, the real space and the virtual space are organically combined and preferably used as an integral part.

There is given an example of a concrete embodiment of the role relation and a concrete motion of the object selection means such that when the role relation between one component and the other component is in a relation that one of the one component and the other component either partially or entirely conceals the other one of the components so as to be invisible from outside, with the one component and the other component are assembled, data showing that one of the one component and the other component either partially or entirely conceals the other one of the components so as to be invisible from outside is set in the role relation data related to the one component and the other component, whereby the object selection means is adapted to refer to the role relation data and to select the component object related to the component of covering side out of the one component and the other component.

There is provided role relation data setting support means that supports to urge designation of a setting target component which is a setting target of the role relation data, to determine whether or not the component object corresponding to the setting target component that receives the designation is displayable to the component object corresponding to the other component, and to set either manually or automatically the role relation data on the other component in the setting target component based on a determination result thus obtained. Therefore, a lot of time and labor relative to setting of role relation data is saved, and convenience remarkably improves.

A concrete embodiment of the role relation data setting support means includes: role relation determining data reception means for receiving the designation of the setting target component, which is the setting target of the role relation data, and the designation of time for determining the role relation, as role relation determining data for determining the role relation of the setting target component at the time thus designated; role relation determination means for determining whether or not the setting target component has a role of covering the other component or being covered by the other component, by determining whether or not the display of the component object corresponding to the setting target component is performable to the component object corresponding to the other component when the component object corresponding to the setting target component and the component object corresponding to the other component are displayed on a screen; and role relation data setting means for setting the role relation data showing that the setting target component has a role of covering side that covers the other component when a determination result reveals that the display of the component object corresponding to the setting target component is performable to the component object corresponding to the other component, and for setting the role relation data showing that the setting target component has a role of being covered by the other component when the display of the component object corresponding to the setting target component is not performable to the component object corresponding to the other component.

When the other component used for determination by the role relation determination means is the component excepting the setting target component, out of all components designated by assembly procedure data corresponding to time shown by the role relation determining data, only designating one component is sufficient and therefore labor saving is realized.

In order to make the role relation data have more implication as a standard component by widening an application range of the role relation data, it is preferable that the role relation data setting support means further comprises: common role relation calculation means for obtaining a common role relation in each assembly procedure by a calculation method such as AND operation, from the role relation obtained for each assembly procedure, and when there are plural assembly procedures, the role relation determination means is adapted to determine the role relation for each assembly procedure; the common role relation calculation means is adapted to obtain the common role relation from the role relation for each assembly procedure determined by the role relation determination means; and the role relation data setting means is adapted to set the common role relation obtained by the logic calculation means as role relation data.

In addition, when the component object is allowed to be designated by component object display data for displaying the component object in the virtual space, as well as by component object identification data capable of identifying the component, the component object identification data can be treated independently of the component object display data while having relation with the component object display data, thus improving a treatability of data.

Moreover, if the component object identification data has metadata capable of reminding of the component or a prescribed concept regarding the component, an outline of the component object can be suitably grasped from the metadata. At this time, if the metadata is data obtained by generalizing a name of the component, the effect becomes remarkable.

Here, the metadata capable of reminding of the component refers to the data by which the worker may directly be reminded of the component, and the metadata capable of reminding of a prescribed concept about the component refers to the data by which the worker may be indirectly reminded of the component. Specifically, a development code, etc., set in a development project of the product is given as an example of the former, and the name of the product which is abbreviated and given to the product is given as an example of the latter. For example, corresponding thereto are the component name “Bnet” referring to component name “bonnet”, and the component name “front BRKLMP” referring to “front brake lamp”. Also, “capable of reminding of” may be just to the extent such that those involved in the production of the product may be reminded, and the number of workers may be more than one.

Further, examples of the metadata as a generalized component name include the data of the component named to show a certain category, the component named to show an attribute, and the component named to show a prescribed constitution. However, robustness is required to keep the worker from being confused with other component name. A person determines whether or not having the robustness, and the component name determined to have the robustness may be received.

In order to suitably grasp the component object selected by the object selection means, it is desirable to have selected object identification data display means for displaying component object identification data related to the component object that has been selected by the object selection means.

Also, in order to suitably grasp the component object not selected by the object selection means, it is desirable to have non-selected object identification data display means for displaying the component object identification data related to the component object that has not been selected by the object selection means.

There is given an embodiment of the component object and the assembly procedure data such that the component object display data is allowed to be communicated on a prescribed communication line, with assembly procedure data accompanied therewith; and the object selection means is adapted to select an appropriate component object by referring to the assembly procedure data accompanied with the component object display data. Alternately, as another embodiment of the present invention, cooperation management means is provided for cooperatively managing the component object display data and the assembly procedure data, wherein the object selection means is adapted to select the appropriate component object by referring to the assembly procedure data cooperatively managed by the cooperation management means.

When display object designation instruction reception means is provided for receiving an instruction for designating the component object arbitrarily displayed in the virtual space, wherein the object display means is adapted to be capable of displaying the component object designated by the instruction received by the display object designation instruction reception means, together with the selected component object or replacing the selected component object. Therefore, for example, it is possible to suitably grasp at which location of the in-process product an unassembled component may be attached in a prescribed in-process stage.

When the component object is adapted to be able to display selectively in a prescribed display mode or a simplified display mode which is more simplified than the prescribed display mode; and

the object display means is adapted to be capable of displaying the component object that has been selected by the object selection means in the prescribed display mode, and the component object that has not been selected by the object selection means in the simplified display mode, the component object that has not been selected by the object selection means can be suitably grasped in the virtual space.

There is provided the display mode designation instruction reception means for receiving an instruction to designate the display mode of the component object, wherein the object display means is adapted to be capable of displaying the component object in the display mode designated by the instruction received by the display mode designation instruction reception means. According to this structure, the component object can be displayed in a desired display mode out of the prescribed display mode and the simplified displayed mode.

As another constitution of the object display device of the present invention, there is provided an object display device, with regard to a product object existing in a virtual space and being assembled by a plurality of component objects, capable of displaying an in-process product on in-process stage of the product object in the virtual space by using the component objects, the object display device comprising: object selection means for selecting the component object to be displayed in the virtual space, out of the component objects constituting the in-process product object, based on assembly procedure data showing an assembly procedure of the product object; and object display means for displaying the component object selected by the object selection means as a selected component object.

### BRIEF DESCRIPTION OF THE DRAWINGS

FIG. 1 is a hardware block diagram of an object display device in one embodiment of the present invention.

FIG. 2 is a functional block diagram of the object display device in the same embodiment.

FIG. 3 is a view systematically showing space element data used in the object display device in the same embodiment.

FIG. 4 is a view systematically showing an assembly procedure data used in the object display device in the same embodiment.

FIG. 5 is a view showing a setting mode of a role relation data in the same embodiment.

FIG. 6 is a joint explanatory view for explaining a joint in the same embodiment.

FIG. 7 is a view showing a storage mode of an assembly procedure data storage means in the same embodiment.

FIG. 8 is a view showing a storage mode of the assembly procedure data storage means in the same embodiment.

FIG. 9 is a view showing the storage mode of a space element data storage means in the same embodiment.

FIG. 10 is a view showing the storage mode of the space element data storage means in the same embodiment.

FIG. 11 is a view showing the storage mode of a cooperation management data storage means in the same embodiment.

FIG. 12 is a view showing the storage mode of the cooperation management data storage means in the same embodiment.

FIG. 13 is a view showing a display mode of an object in the same embodiment.

FIG. 14 is a view showing the display mode of the object in the same embodiment.

FIG. 15 is a view showing the display mode of the object in the same embodiment.

FIG. 16 is a view showing the display mode of the object in the same embodiment.

FIG. 17 is a view showing the display mode of the object in the same embodiment.

FIG. 18 is a flowchart showing an operation of the object display device in the same embodiment.

FIG. 19 is a flowchart showing the operation of the object display device in the same embodiment.

FIG. 20 is a flowchart showing the operation of the object display device in the same embodiment.

FIG. 21 is a flowchart showing the operation of the object display device in the same embodiment.

FIG. 22 is a flowchart showing the operation of the object display device in the same embodiment.

FIG. 23 is a flowchart showing the operation of the object display device in the same embodiment.

FIG. 24 is a screen transit view in the same embodiment.

FIG. 25 is a functional block diagram of the object display device in another embodiment of the present invention.

FIG. 26 is a view for explaining the operation according to a determination of a role relation determination means in the same embodiment.

FIG. 27 is a view showing a cooperation mode between metadata and role relation data in the same embodiment.

FIG. 28 is a flowchart showing the operation of the object display device in the same embodiment.

### BEST MODE FOR CARRYING OUT THE INVENTION

### First Embodiment

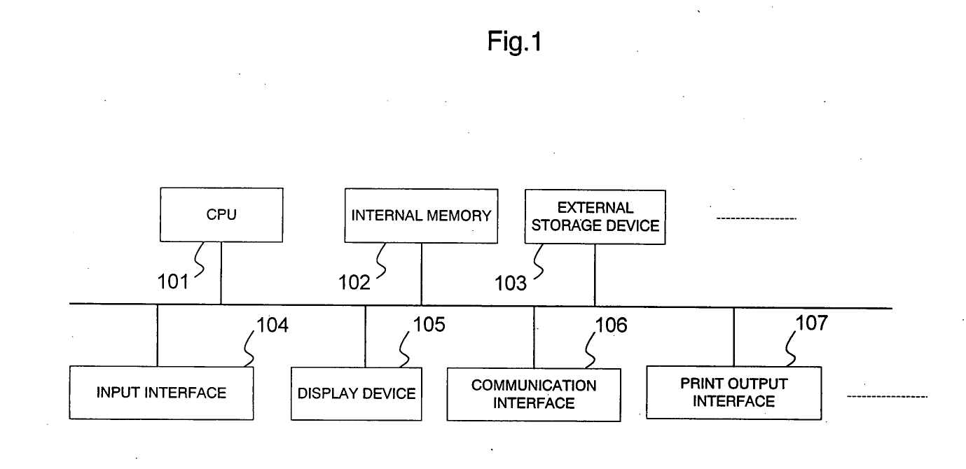

An embodiment of the present invention will be explained with reference to FIG. 1 to FIG. 24.

An object display device P in an embodiment of the present invention is designed to be capable of displaying components constituting a product so as to be able to assemble in a virtual space as component objects. Then, by displaying an in-process product in an in-process stage of the product by using the component objects in the virtual space as in-process product objects, and by sequentially assembling the component objects in the in-process product objects, namely, by sequentially displaying the component objects, the object display device P is suitably used for examining workability during assembling the product in a real space and adequacy of a production line of the product.

It should be noted that the product used for explanation in this embodiment is designed to be completed through a plurality of steps, and each step is also composed of a plurality of element works.

Moreover, each component is managed by component management number, which is the number of components, and in addition, component supply unit management number is given to a component supply unit for holding a prescribed component, so as to manage it.

The virtual space in this embodiment is realized by executing a program recorded in a recording medium for control described in “METHOD AND DEVICE FOR CONTROLLING DISPLAY STATE IN THREE-DIMENSIONAL SPACE DISPLAY SYSTEM AND RECORD MEDIUM FOR CONTROL” (Japanese Patent Application Laid Open No. 11-272891) by the object display device P. Note that the technology for realizing the virtual space is not limited thereto.

Further, the object arranged in the virtual space is arranged with respect to the other object and the virtual space by using a method described in “METHOD AND DEVICE FOR MOVEING AND ARRANGING OBJECT IN THREE-DIMENSIONAL SPACE DISPLAY SYSTEM AND RECORD MEDIUM FOR CONTROL” (Japanese Patent Application Laid Open No. 11-272892).

Next, the virtual space will be specifically explained. The virtual space is composed of a plurality of virtual space elements. Note that the virtual space element may be singular in accordance with an embodiment.

In this embodiment, each virtual space element is provided with joints as will be described later that can be connected to the component object as will be described later and the component supply unit object as will be described later. The movement of the component object and the component supply unit object (referred to as objects hereafter) to the arbitrary position in the virtual space is performed following the connection of the joints.

Namely, when the joints are defined for the objects and the virtual space elements, an arrangement is made following the joints, and when the joints are not defined, the arrangement is made following the method described in the aforesaid “DEVICE AND METHOD FOR MOVING AND ARRANGING OBJECT IN THREE-DIMENSIONAL SPACE DISPLAY SYSTEM” (Japanese Patent Application Laid Open No. 11-272892).

The object display device P will be specifically explained hereafter.

The object display device P has a general information processing function, and as shown in FIG. 1, has a CPU 101, an internal memory 102, and an external storage device 103 such as HDD or the like, an input interface 104 such as mouse and keyboard, a display device 105 such as a liquid crystal display, a communication interface 106 for being connected to a communication line network such as an in-house LAN and internet, and a print output interface 107 for printing out to a printer (not shown), and so forth.

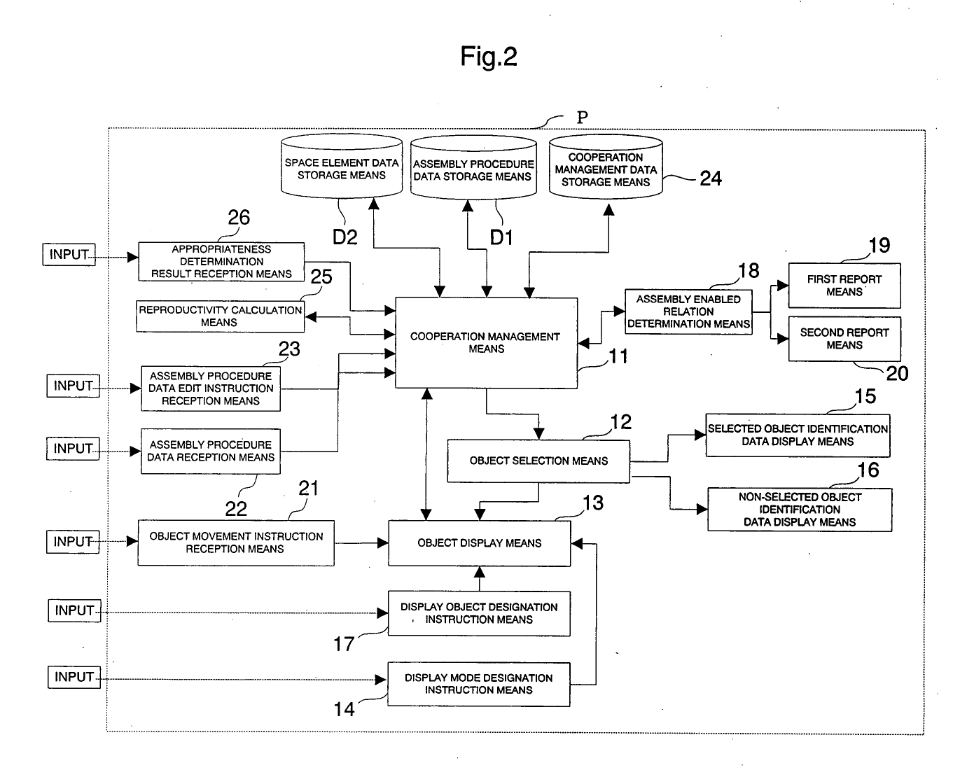

Then, the object display device P causes the CPU 101 and peripheral equipment to be activated in accordance with a display program stored in the internal memory 102, and as shown in FIG. 2, exhibits the function as cooperation management means 11, object selection means 12, object display means 13, display mode designation instruction reception means 14, selected object identification data display means 15, non-selected object identification data display means 16, display object designation instruction reception means 17, assembly enabled relation determination means 18, first report means 19, second report means 20, object movement instruction reception means 21, assembly procedure data reception means 22, assembly procedure data edit instruction reception means 23, cooperation management data storage means 24, reproductivity calculation display means 25, appropriateness determination result reception means 26, and so forth.

Each means will be described hereunder in detail. Before that, the assembly procedure data and the space element data, which are data treated by the object display device P, will be explained. Note that in this embodiment, the assembly procedure data and the space element data have metadata by which they are cooperatively managed.

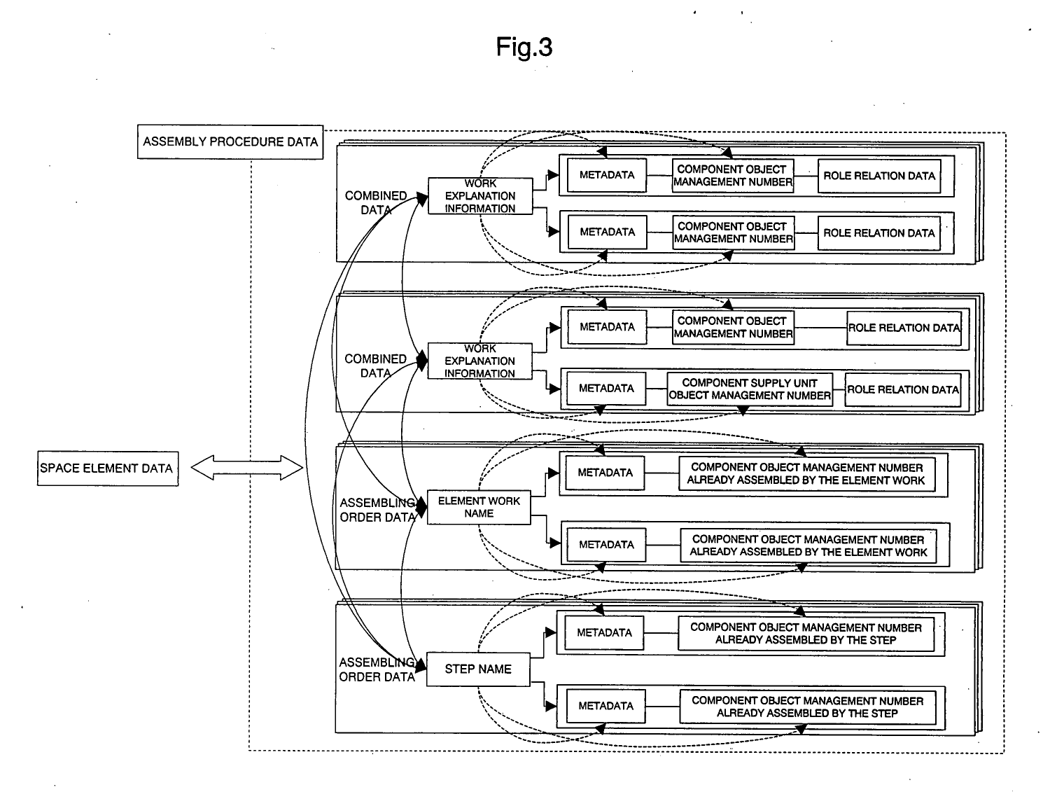

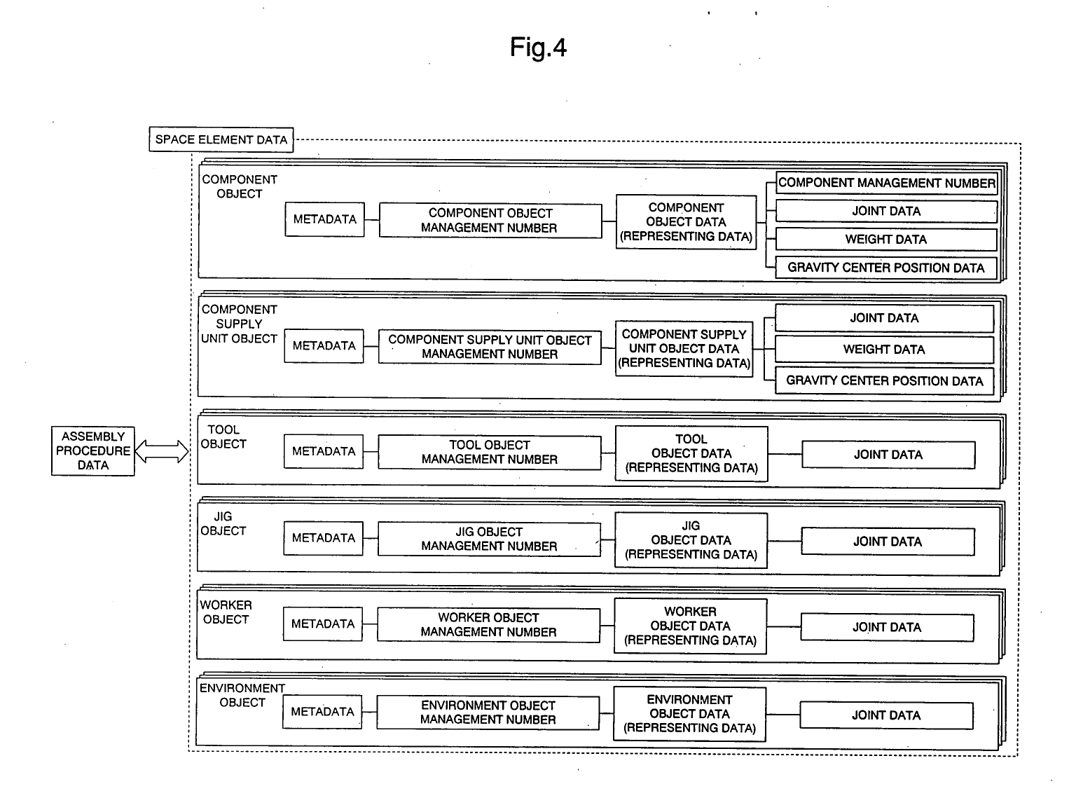

FIG. 3 and FIG. 4 systematically show the structure of the data treated in the object display device P.

First, the assembly procedure data will be explained. As shown in FIG. 3, the assembly procedure data is the data composed of combined data related to the combination of assembly enabled components and assembling order data related to the assembling order thereof.

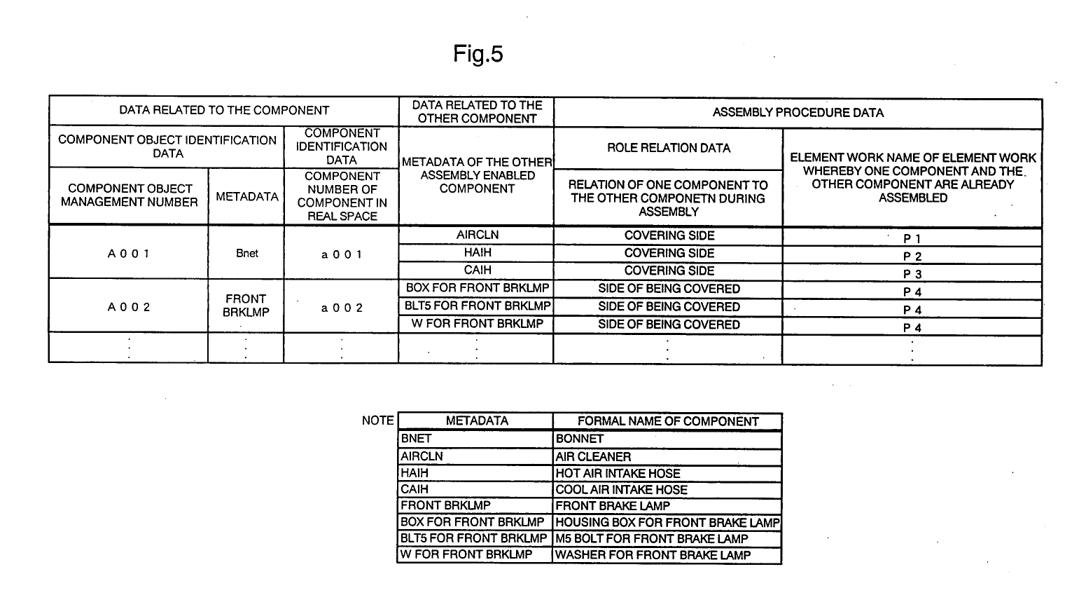

More specifically, the combined data is composed of the data described by associating the component object management numbers of the assembly enabled components for showing the assembly enabled component, and the data described by associating the component supply unit object management number of the component supply unit and the component object management number of the component that can be held by the component supply unit for showing the combination of the component supply unit and the component that can be held by the component supply unit. Then, the component object management number and the component supply unit object management number are described in association with work explanation information, the metadata, and role relation data. Here, the work explanation information is the information explaining the work related to the element work or the step, including not only an expression directly showing the work but also an expression indirectly suggesting the work. The expression, “component A and component B are assembled” is given as an example of the former, and the expression, “bolt and nut of M5 are assembled in the component A, but a length of the bolt and an outer diameter of the nut may be arbitrarily set” is given as an example of the latter. In addition, the role relation data shows a role relation between components and between the component and the component supply unit. More specifically, there is an example such that when the role relation between one component and the other component is in a relation that the component of either one of the one component or the other component conceals a part or an entire part of the other component so as to be invisible from outside, with the one component and the other component assembled, data of “covering side” is set in the role relation data of one component showing that a part or the entire part of the component is concealed by either one of the one component or the other component so as to be invisible from outside, and data of “the side being covered” is set in the role relation data of the other component showing that a part of or the entire part of the other component is concealed so as to be invisible from outside by one component. More specifically, in the role relation between one component (bonnet) and the other component (air cleaner), the one component (bonnet) covers the entire part of the other component (air cleaner) so as to be invisible from outside in an assembled state of them. Therefore, “covering side” is set in the role relation data related to the one component (bonnet), and “the side being covered” is set in the other component (air cleaner) (see FIG. 5). It should be noted that as is seen in the relation between the bonnet and the air cleaner, even if not in a directly assembly enabled relation, if the components can be indirectly assembled through the other component, the relation of the components corresponds to the “assembly enabled role relation” specified by this embodiment. Further, the role relation data is not limited to being set between component objects, but is set for all the objects that can be displayed in the virtual space, such as the role relation of the component supply unit object and a worker object with respect to the component object.

In addition, the assembling order data is composed of the data described by associating element work name and the component object management number which has been assembled by the element work, and the data described by associating step name and the component object management number which has been assembled in the step.

Next, space element data will be explained. The space element data is the data for representing “an object” that can exist in the real space, and is composed of the component object data which is component object display data, component supply unit object data, tool object data, jig object data, and worker object data, etc. in this embodiment, as shown in FIG. 4.

More specifically, the component object data is representation data for displaying the components in the virtual space as component objects. Also, the component supply unit object data is the representation data for displaying the component supply unit as a component supply unit object in the virtual space. The tool object data is the data for representing a tool in the virtual space as a tool object. Here, the tool refers to the tool used in machining, such as a driver, a torque wrench, and an electric drill. Jig object data is the data for representing a jig as a jig object in the virtual space. Here, the jig refers to an auxiliary implement used for guiding the tool to a prescribed position during machining. The worker object data is the data for representing a worker as a worker object in the virtual space.

Then, the component object management number and the component supply unit object management number are given to the aforementioned component object data and component supply unit object data, respectively, thus making it possible to manage them by each number. Note that identification is not limited to the number, but may be a sign or a mark, and a combination thereof, provided that they can thereby be identified. In addition, the same management number is also given to the tool object data, jig object data, and worker object data, and so forth, and the explanation is omitted.

Further, the component management number, joint data, weight data, and gravity center position data are associated with one another and described in the component object data.

The component management number adopts the component number given to the component. However, the present invention is not limited thereto, and is suitably set in accordance with the embodiment. For example, a figure number given to the figure for manufacturing the component is adopted.

The joint data is the data related to the joint capable of being connected to other component object, the component supply unit object, and the virtual space. One or plural joints can be set for one component object in accordance with an embodiment. Also, the position at which the joint is set can be arbitrarily selected in accordance with the embodiment.

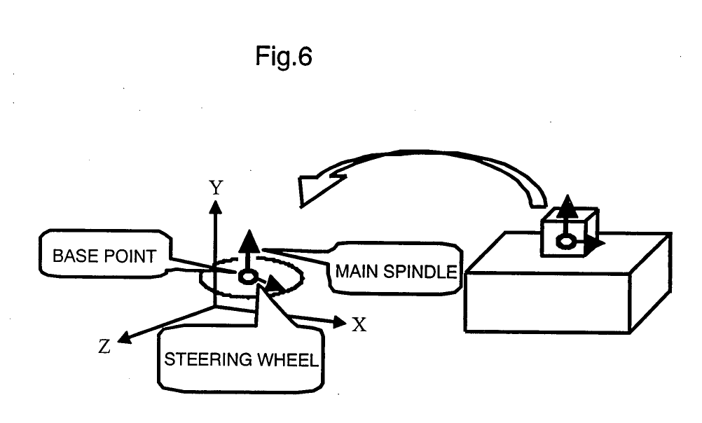

Here, as schematically shown in FIG. 6, joint J is described as a set of a base-point coordinate, main axial vector component, and vector component in a handle direction, and can be described at various degree of freedom, basically by present/absent of main axial vector and handle vector, and an attribute definition thereof. Then, by defining the degree of freedom of objects one another, each object can be connected through the joint. For example, bolt objects (not shown), which is the component objects, are connected by the joint (not shown) therebetween, so as to have a freedom movable only in a direction in which the bolt objects can be fastened and loosened to nut objects (not shown) which is the component objects.

In this embodiment, when one component object and the other component object are connected in the virtual space, and when there is a plurality of joints in the one component object, the component object is connected to the joint which is closest thereto in the other component object, out of the plurality of joints. A connection method in this case is not limited to the aforementioned condition, and the component object may be connected to the joint by other condition such as being connected to a high-priority joint.

In addition, a plurality of component objects, which have already been assembled in a prescribed manner, i.e. already connected by joints, are formed as a component object group that can be integrally treated, so as to be able to move in the virtual space.

Then, the connection of the object group and the object, and the connection of each object group are specified by drag and drop by mouse, specified as the object group picked by mouse, or selected from the list.

The weight data is the data showing an actual weight of the component in the real space. As for the weight data, not the actual weight is shown but a virtual value can be given as the weight data.

The gravity center position data is the data showing a gravity position in the real space. As for the gravity center position data, not only the data completely corresponding to the gravity center of an actual component can be set as the gravity center position data, but also a virtual value can be given as the gravity center position data.

To return to main discussion, each means will be described in detail.

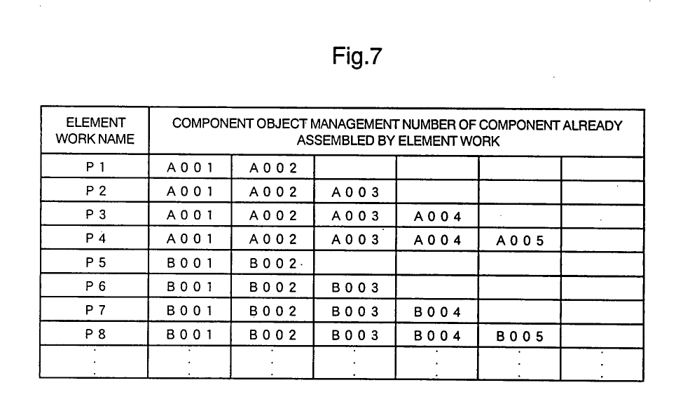

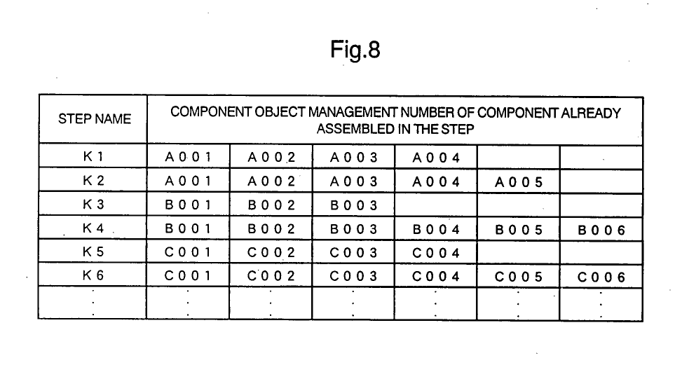

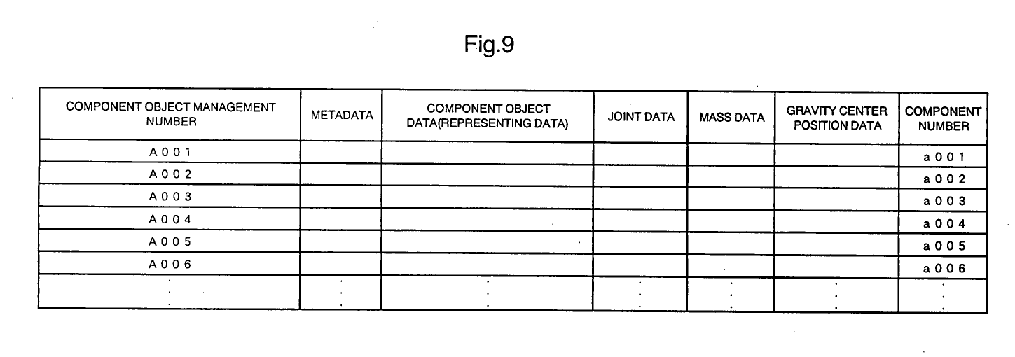

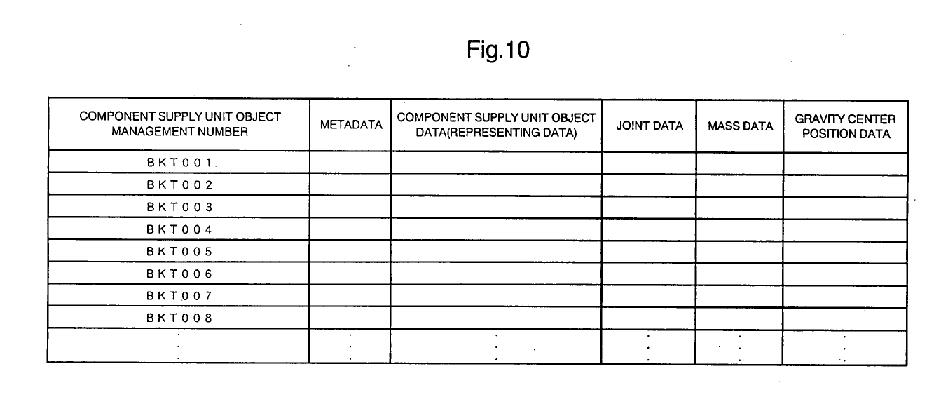

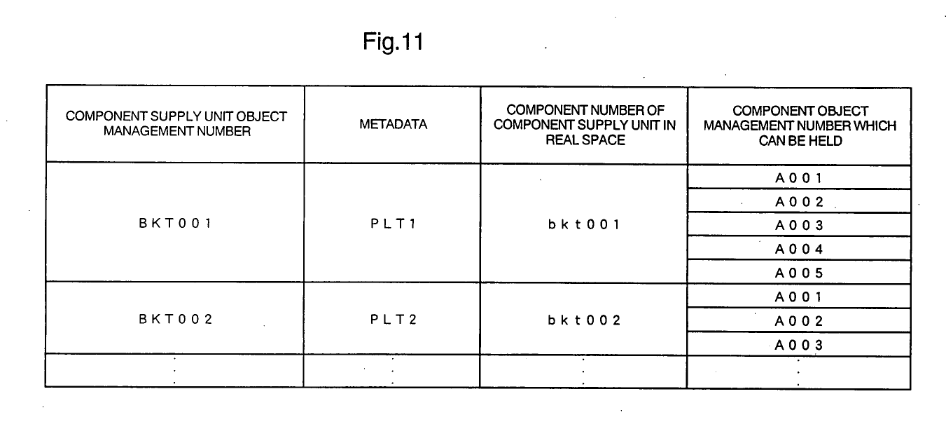

The cooperation management means 11 performs cooperative management by associating the assembly procedure data stored in assembly procedure data storage means D1 (see FIG. 7 and FIG. 8) and the space element data stored in space element data storage means D2 (see FIG. 9 and FIG. 10) as corporative management data, and they are stored in the cooperation management data storage means 24 as will be described later. Note that in this embodiment, as shown in FIG. 11, the component supply unit object management number and the component object management number are used to associate the assembly procedure data and the space element data.

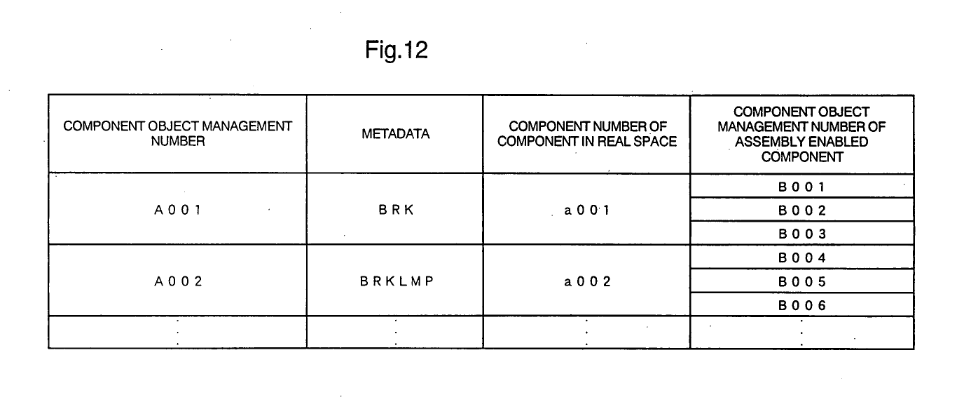

In addition, in this embodiment, as shown in FIG. 12, the component object management number and the component management number are associated, so that the component in the real space and the component object in the virtual space are cooperatively managed. Then, they are stored in the cooperation management data storage means 24 as will be described later, to cooperatively manage them.

The object selection means 12 selects the component object to be displayed in the virtual space out of the component objects constituting the in-process product object, based on the assembly procedure data.

More specifically, in this embodiment, the object selection means 12 refers to the role relation data of the assembly procedure data, and selects the component object related to the component of the concealing side out of one component and the other component.

A further specific example is explained in which the in-process product object to be displayed in the virtual space is assumed to include a bonnet object and an air cleaner object. In this case, the object selection means 12 operates so as to refer to the role relation data related to the bonnet object and the role relation data related to the air cleaner object stored in the assembly procedure data storage means D1 (see FIG. 6), and to select the bonnet object which is the “covering side” with respect to the air cleaner object, as the component object to be displayed in the virtual space, but not to select the air cleaner object.

In this embodiment, the object selection means 12 selects an appropriate component supply unit object, tool object, jig object, and worker object, in the same way as selecting an appropriate component object.

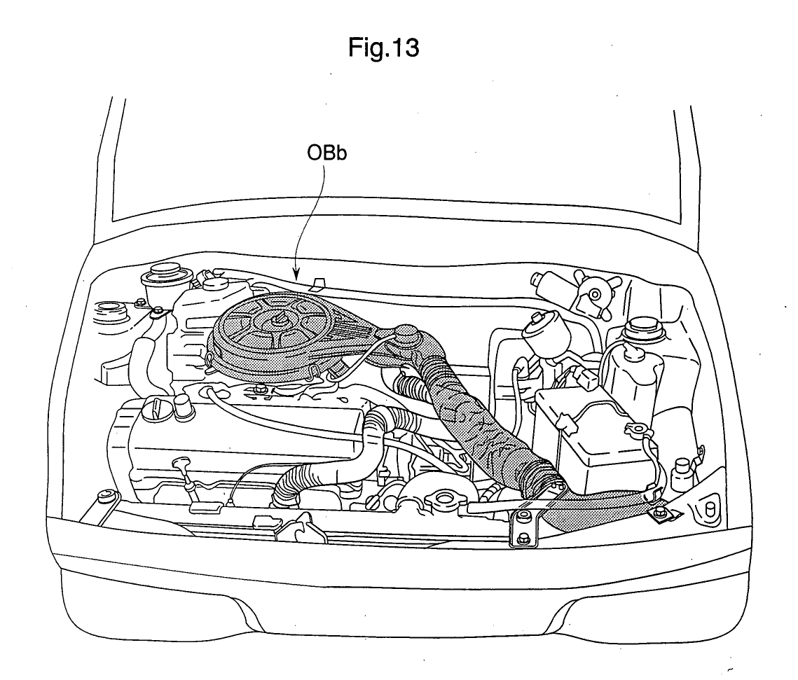

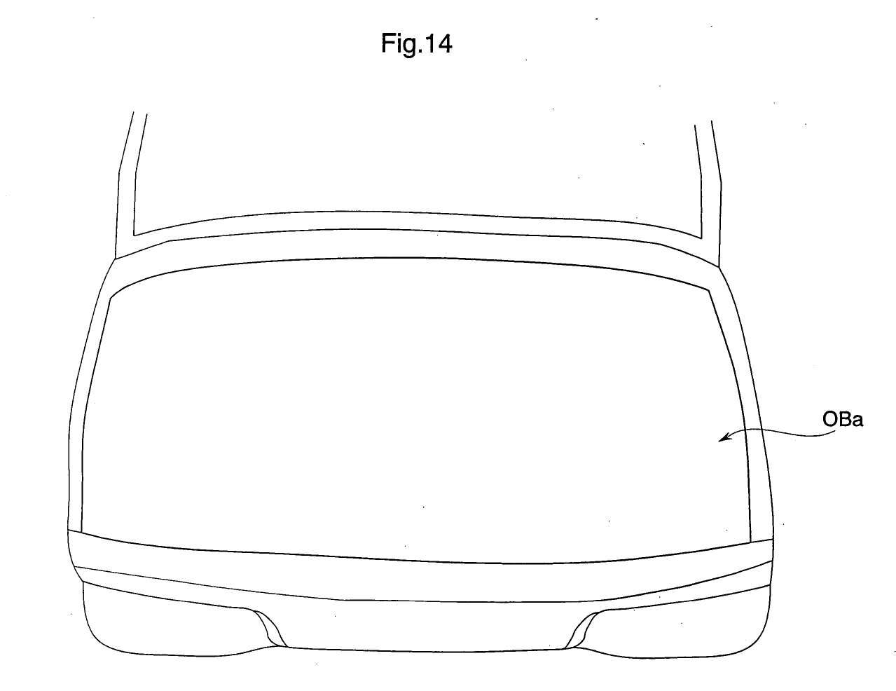

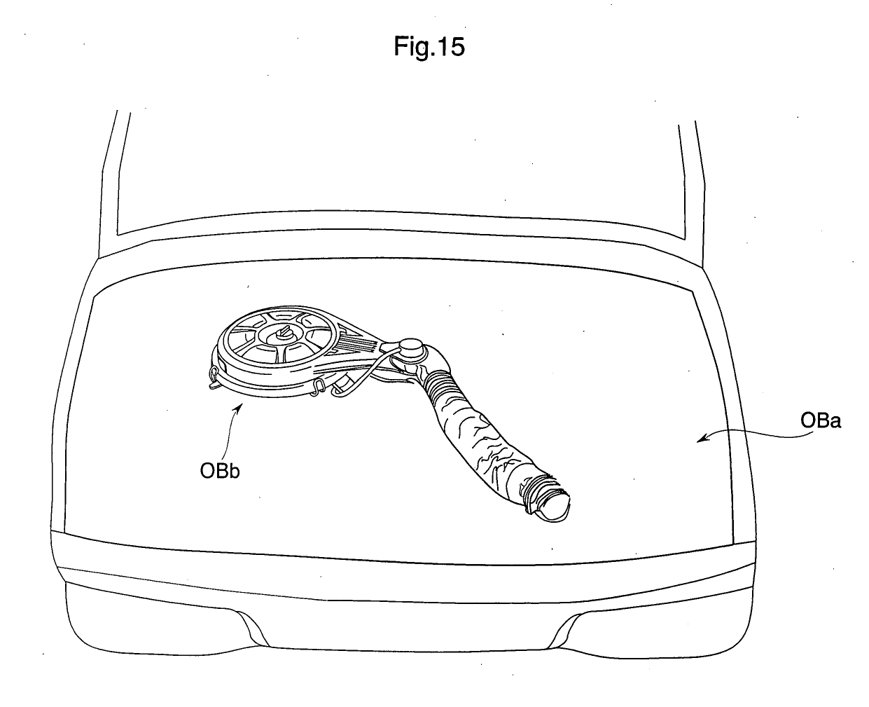

As shown in FIG. 13, FIG. 14, and FIG. 15, the object display means 13 can display the component as the component object in the virtual space based on the component object data stored in the space element data storage means D2, wherein the display device 105, etc., is used. In this embodiment, the object display means 13 can display the component supply unit object, tool object, jig object, and worker object in the same way as displaying the component object.

In this embodiment, when the object display means 13 displays the component object, component supply unit object, tool object, jig object, and worker object, the display thereof is restricted based on a selection result of the object selection means 12. Specifically, the object display means 13 displays the component object, component supply unit object, tool object, jig object, and worker object (hereafter generally referred to as object group) selected by the object selection means 12 in the virtual space, as selected component object, selected component supply unit object, selected tool object, selected jig object, and selected worker object (hereafter generally referred to as selected object group), while non-selected object group (hereafter generally referred to as non-selected object group) is not displayed.

Further, in this embodiment, on assembling one object group with other object group, when a part or the entire part of the one object group conceals only a part of the other object group, such a relation between the one object group and the other object group is set in the role relation. Then, when the one object group and the other object group have such a role relation, the object selection means 12 selects both of the object groups, and the object display means 13 displays both object groups in the virtual space by almost truthfully re-creating an overlapping behavior shown by the role relation. Here, in order to realize that “both object groups are displayed in the virtual space by almost truthfully re-creating an overlapping behavior shown by the role relation”, it is preferable to set the data in the object data group for displaying the object group, so as to show a display mode in accordance with the role relation.

Specifically, the role relation is constituted to have a target established in the expression of a work instruction. Thus, non-display control of data is effectively performed, wherein not only an internal component but also an external component is not displayed. For example, when the role relation is set based on a viewpoint that “it is satisfactory only to identify “this is an engine” or “this is a transmission” as a unit, even if it is the external component”, non-display control of data having high efficiency can be realized in accordance with an application operation, while almost truthfully re-creating the overlapping behavior shown by the role relation, which cannot be realized by the conventional occlusion culling.

An example of this is given such that based on the viewpoint that “an assembly of the engine is completed when a cylinder head cover (uppermost part) and an oil pan (lowermost part) are attached, and therefore it is satisfactory only to see an approximate overview of the engine in a subsequent work of the component other than the engine, and the component other than some components constituting an external part, which are regarded as characteristics of the engine, (such as head cover, oil pan, exhaust pipe, fan belt) are not displayed”, data such that follows is set as role relation data of an engine object: data indicating “when the cylinder head cover (uppermost part) and the oil pan (lowermost part) are attached and the assembly of the engine is completed, the components other than the head cover, oil pan, exhaust pipe, and fan belt are not displayed in the subsequent work of the component other than the engine”, and “the head cover, oil pan, exhaust pipe, and fan belt are displayed in a prescribed display mode and the other components are displayed in a simplified display mode”.

The display mode designation instruction reception means 14 receives the instruction to designate the display mode of the object group, wherein the input interface 104, etc., is used. Then, when the display mode designation instruction reception means 14 receives a display mode designation instruction, the object display means 13 can display the object group in the display mode designated by the display mode designation instruction thus received.

Specifically, the display mode designation instruction reception means 14 receives either one of the display mode designation instruction, out of the display mode designation instruction showing that the object group is displayed in a prescribed display mode and the display mode designation instruction showing that the object group is displayed in a more simplified display mode than the prescribed display mode. Accordingly, the object display means 13 displays a selected object group in the prescribed display mode or the simplified display mode, based on the display mode designation instruction received by the display mode designation instruction reception means 14.

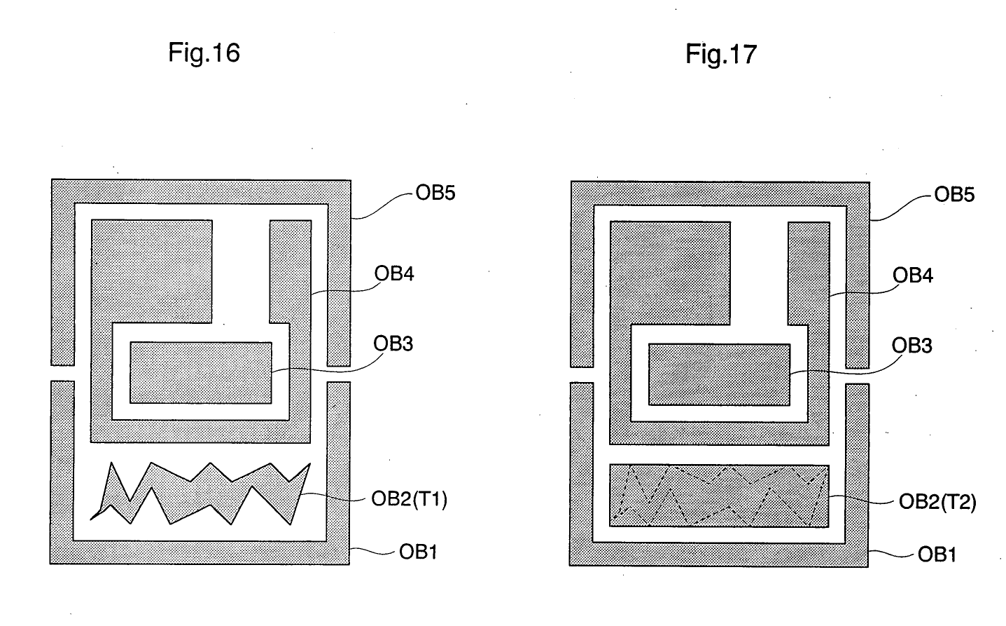

Here, the described display mode in this embodiment is defined as such displayed to the extent that when the component object is displayed in the prescribed display mode, an operator, etc., operating the object display device P can recognize an approximate shape of the component and what the component is (for example, OB2 (T1) in FIG. 16), for example. Meanwhile, the simplified display mode is defined as such displayed to the extent that when the component object is displayed in the simplified display mode, the operator recognizes an existence of the component but he/she cannot recognize what the component is (for example, OB2 (T2) in FIG. 17). In this embodiment, the data for being displayed in the prescribed display mode and the data for being displayed in the simplified display mode are stored in the space element data storage means D2 (not shown) However, only the data for being displayed in the prescribed display mode may be stored in the space element data storage means D2, and the data may be displayed in the simplified display mode by suitably arithmetically processing it from the data which is displayed in the prescribed display mode, when the data is displayed in the simplified display mode.

The selected object identification data display means 15 displays the component object identification data related to the component object selected by the object selection means 12, wherein the display device 105 is used.

Note that in this embodiment, the selected object identification data display means 15 displays a list of the component object identification data selected by the object selection means 12 (not shown). However, the display mode is not limited thereto.

Further, in this embodiment, the selected object identification data display means 15 can also display the object identification data related to the selected component supply unit object, selected tool object, selected jig object, and selected worker object, in addition to the selected component object.

The non-selected object identification data display means 16 displays the component object identification data related to the component object not selected by the object selection means 12, wherein the display device 105, etc., is used.

In this embodiment, the non-selected object identification data display means 16 displays the list of the component object identification data not selected by the object selection means 12 (not shown). However, the display mode is not limited thereto.

Further, in this embodiment, the non-selected object identification data display means 16 can also display the object identification data related to the non-selected component supply unit object, non-selected tool object, non-selected jig object, and non-selected worker object, in addition to the non-selected component object.

The display object designation instruction reception means 17 receives the instruction to designate the component object arbitrarily displayed in the virtual space, wherein the input interface 104, etc., is used. In this embodiment, the non-selected object identification data, whose list is displayed by the non-selected object identification data display means 16, is designated and received by mouse click, or the like. However, its receiving method can be suitably set in accordance with the embodiment. For example, the selected object identification data whose list is displayed by the selected object identification data display means 15 can be received by designating it by mouse click or the like.

Then, in this embodiment, when the display object designation instruction reception means 17 receives the display object designation instruction, the object display means 13 displays the component object designated by the instruction in the virtual space together with the selected component object. Note that the component object designated by the instruction received by the display object designation instruction reception means 17 may be displayed replacing the selected component object.

In addition, in this embodiment, the display object designation instruction reception means 17 receives the instruction to designate the component supply unit object, tool object, jig object, and worker object, in addition to the component object, and the object display means 13 can display in the virtual space the component supply unit object, tool object, jig object, and worker object that are designated by the instruction, together with the selected component object.

The assembly enabled relation determination means 18 determines whether or not one component and the other components related to the component object displayed in the virtual space are in the assembly enabled state, based on the assembly procedure data managed by the cooperation management means 11.

In this embodiment, as the method of determining whether or not the aforementioned component objects are in the assembly enabled state, (a) the method of determining it based on the assembling order is at least adopted, and in addition, (b) the method of determining it based on a combination of components is adopted as needed.

Specifically, (a) the method of determining it based on the assembling order is the method of determining whether or not a certain component and a certain component are in the assembly enabled state, and when there is no discrepancy between the component object management numbers of these components and the combination of the component object management numbers, in the order of element work names or the order of steps, it is determined to be assembly enabled. When there is a discrepancy therebetween, it is determined not to be able to assemble them.

As an example, with reference to FIG. 7, an explanation will be given to the method of determining whether or not component object management number A005 is in the assembly enabled relation with component object management numbers A001 to A004. Because the component object management number A005 is added to element work names P3 through P4, the component object management number A005 is determined to be in the assembly enabled relation with the components related to the component object management numbers A001 to A004 related to the element work name P4. Meanwhile, the component object management number A005 is not added to any element work name P1 to P2, P2 to P3, and P3 to P4. Therefore, the component object management number A005 is determined to be not in the assembly enabled relation with the components related to the element work names P1 through P3.

Specifically, in the method (a), the assembly enabled relation determination means 18 can be defined as means for determining whether or not one component and the other components related to the component object displayed in the virtual space have assembly enabled relation, by calculating the change (such as a change from the element work names P1 to P2) from the previous state in the element work and determining whether or not an instruction (such as an instruction to assemble the component object management number A005 into A001 to A004) intended to be given in the next element work is established in this element work.

(b) The method of determining it based on a combination of component is the method of determining whether or not a certain component and a certain component have the assembly enabled relation. Specifically, the component is determined to be able to assemble when the component object management number of the component is stored in the cooperation management data storage means 24 as will be described later as the component object management number of the component already assembled in the element work or step under the element work name or step name, and the component is determined not to be able to assemble when one of or both of the element work name and the step name are not stored therein.

As an example, with reference to FIG. 8, the explanation will be given to the method of determining whether or not the component object management number A005 is in the assembly enabled relation with the component object management numbers A001 and B001. This component object management number A005 is stored correspondingly to the component object management number A001 under the element work name P4, and is therefore determined to be in the assembly enabled relation with the component related to the component object management number A001, and meanwhile is determined to be in the relation not to be able to assemble with the component related to the component object management number B001 in the combination of components, because the component object management number B001 is not stored correspondingly to the component object management number A005 under any element work name.

As to steps also, the assembly enabled relation determination means 18 determines the assembly enabled relation based on a storage mode shown in FIG. 8. However, this method of determination is the same as a case of determination for the element work, and therefore the explanation thereof is omitted.

When the assembly enabled relation determination means 18 determines the relation not to be able to assemble in the combination of the components in the assembly procedure data, the first report means 19 reports accordingly.

In this embodiment, the information is reported by displaying on screen by the first report means 19, in such a way that not only the information showing an assembly disenabled relation, but also the information suggesting the combination of assembly enabled components is displayed on screen. However, the information may also be reported in such a way that the information suggesting the combination of the assembly enabled component is replaced with the information showing the assembly disenabled relation.

When the assembly enabled relation determination means 18 determines the assembly disenabled relation in the assembling order in the assembly procedure data, a second report means 20 reports accordingly.

In this embodiment, the information is reported by displaying on screen by the second report means 20, in such a way that not only the information showing the assembly disenabled relation, but also the information suggesting the assembly procedure which can be assembled is displayed on screen. However, the information may also be reported in such a way that the information suggesting the assembly procedure which can be assembled is replaced with the information showing the un-assemblable relation.

The object movement instruction reception means 21 receives the instruction to move the component object and the component supply unit object displayed in the virtual space, to the arbitrary position in the virtual space as an object movement instruction, wherein the aforementioned input interface 104, or the like is used.

As a specific instruction received by the object movement instruction reception means 21, an example is given such as the instruction to indicate the object displayed in the screen by a mouse and drag and drop it to a desired position.

Note that it goes without saying that the object display means 13 displays the object, following an object movement instruction received by the object movement instruction reception means 21.

The assembly procedure data reception means 22 is provided for receiving the assembly procedure data related to the prescribed product or the assembly procedure data related to other product different from the prescribed product, wherein the aforementioned communication interface 106 is used. Note that instead of using the communication interface 106, for example, the data recorded in a recording medium such as a CD-ROM may also be received.

The assembly procedure data edit instruction reception means 23 receives the instruction to edit at least either one of the data of the combination or assembling order of the components in the assembly procedure data, wherein the aforementioned input interface 104, etc., is used.

More specifically, for example, there is the assembly procedure data edit instruction reception means for receiving the instruction to delete the component object management number A001 of the element work name P1 or change it to the other component object management number. At this time, a changeable component object management number may be displayed by pull down menu or the like.

The cooperation management data storage means 24 stores the assembly procedure data and space element data cooperatively managed by the cooperation management means 11, as cooperatively management data in a state of being cooperatively managed, and is formed in at least one prescribed region of the internal memory 102 and the external storage device 103.

The reproductivity calculation display means 25 calculates and displays a reproductivity based on a character string of a search source and the character string of a search destination. Although in this embodiment, the metadata is used in the character string of the search source and the character string of the search destination, the present invention is not limited thereto, and for example, the component management number and the component object management number may be used, or work explanation information may be used. The reproductivity calculation display means 25 displays the reproductivity to be calculated in descending order from a larger value. However, it can be displayed by an appropriate method such as displaying in ascending order or displaying only a prescribed value or more.

The reproductivity will be more specifically explained. The reproductivity is an index value for selecting the value closer to the character string of the search source from a plurality of search destinations, which is defined by reproductivity=Σ (the number of appearance of characters constituting the character string in the search destination)/(the number of appearance of characters constituting the character string in the search source). Note that in this embodiment, alphabet is adopted in the character for obtaining the reproductivity. Accordingly, a sum total of reproductivity of A, reproductivity of B, . . . reproductivity of Z becomes the reproductivity. Also, the character for obtaining the reproductivity is not limited to alphabet, but may include numeric characters, signs and marks, Chinese characters, Japanese characters, and Katakana. Further, a graphic such as a mark may also be included.

An example will be given for explanation. For example, it is assumed that there is one search source and its character string is “BRAKELAMP”, and there are three search destinations and their character strings are “BRK”, “BRKLMP”, and “BRKPAD”.

First, as to the search source “BRAKELAMP”, what character appears is obtained. Then, it is found that B, R, K, E, L, M, and P respectively appear once, and A appears twice. Therefore, A=2, B=1, E=1, K=1, L=1, M=1, P=1, and R=1 are obtained.

Next, as to the search destination “BRK”, an appearance of the character is obtained. Then, it is found that the character A does not appear, and therefore 0/2=0 is obtained as the reproductivity related to A. Similarly, 1/1=1 is obtained as the reproductivity related to B, 0/1=0 is obtained as the reproductivity related to E, 1/1=1 is obtained as the reproductivity related to K, 0/1=0 is obtained as the reproductivity related to L, 0/1=0 is obtained as the reproductivity related to M, 0/1=0 is obtained as the reproductivity related to P, and 1/1=1 is obtained as the reproductivity related to R. Accordingly, the sum total thereof becomes 0+1+0+1+0+0+0+1=3, and 3 is obtained as the reproductivity of the search destination “BRK”.

Similarly, 6 is obtained as the reproductivity of the search destination “BRKLMP”, and 4.5 is obtained as the reproductivity of the search destination “BRKPAD”.

Note that the method of calculating the reproductivity is not limited thereto.

The appropriateness determination result reception means 26 receives as a determination result the search source and the search destination to be cooperated, which are determined to be in a appropriateness relation by a user, based on the reproductivity displayed by the reproductivity calculation display means 25, wherein the aforementioned input interface 104 or the like is used.

Next, an operation of an object display device P of this embodiment will be explained by using a flowchart, etc.

For convenience of the explanation, the explanation is given according to flowcharts (1) to (6). These flowcharts can be processed independently or in parallel in accordance with the embodiment.

(1) Flow related to selection and display of the object.

An explanation is started by assuming that only one component object is displayed in the virtual space of an initial screen.

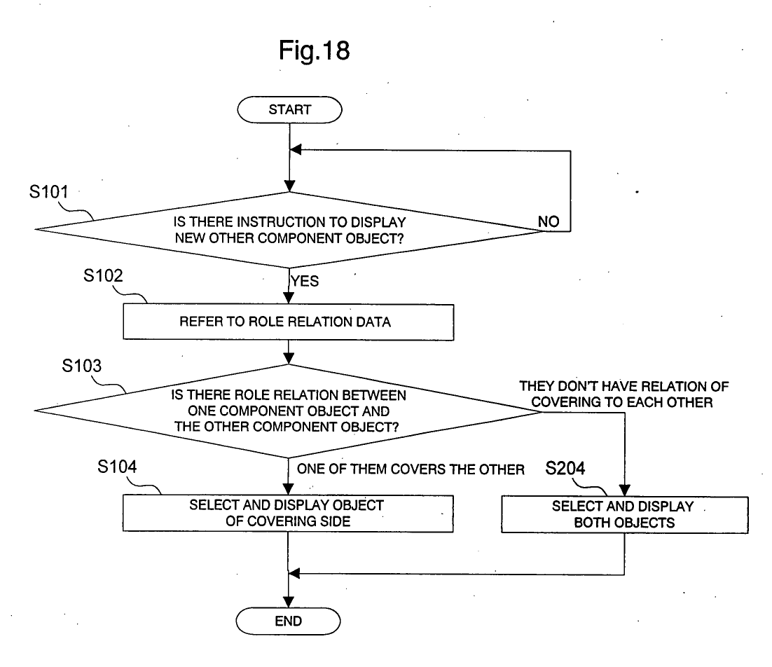

As shown in FIG. 18, when there is a command to display a new other component object in the virtual space where one object is displayed (step S101), the object selection means 12 refers to the role relation data of the one component object and the role relation data of the other component object (step S102), and when it determines that either one of the one component object and the other component object has the role relation of covering the other component object (step S103), selects the component object of the covering side, and displays the component object selected by the object display means 13 in the virtual space (step S104). Meanwhile, in the role relation of the one component object and the other component object, when the object selection means 12 determines that both of them do not have the role relation of covering the other component object (step S103), selects the both component objects, and the object display means 13 displays the both component objects in the virtual space (step S104). Thus, the in-process product object constituted of a plurality of component objects is displayed on the screen.

Then, the processing similar to that of step S102 to S104 is applied to the component object displayed in the virtual space, every time the command to display the new other component object is received. In addition, similar processing is applied to the component supply unit object also, not limited to the component object.

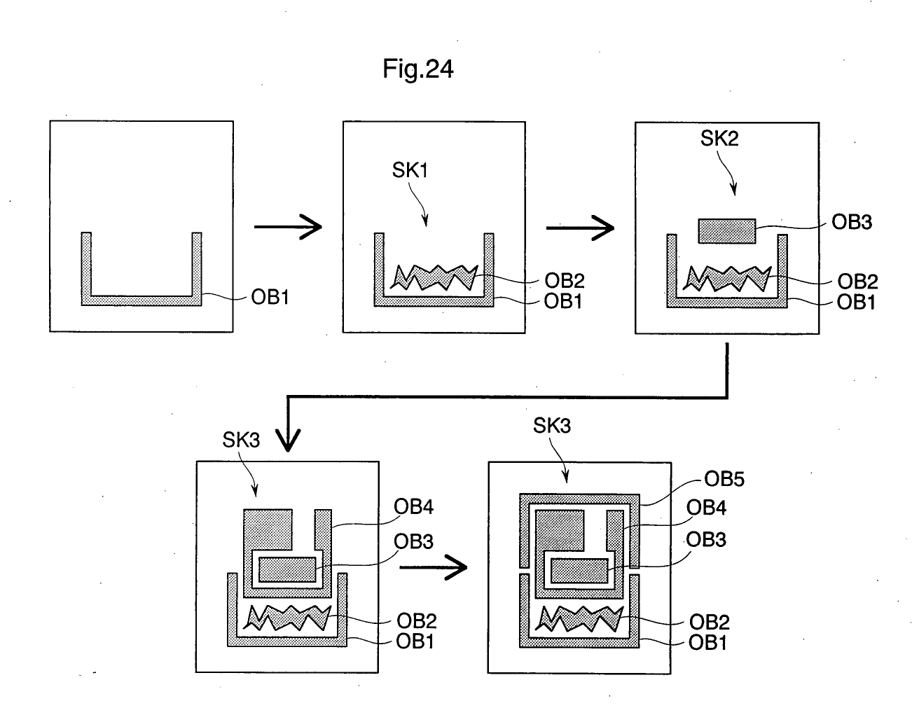

FIG. 24 shows by a transition diagram a process of forming in-process product objects SK2, SK3, SK4 by a plurality of component objects, by sequentially assembling component objects OB1, OB2, OB3, OB4, OB5. For example, when the role relation is set as “the component object OB4 has a relation of covering the component object OB3” in a state of a screen where the in-process product object SK3 is displayed, the component object OB3 is not displayed, and when the role relation is set as “the component object OB4 does not have the relation of covering the component object OB3”, the component object OB3 is displayed.

(2) Flow related to the movement and display of the object displayed on the screen.

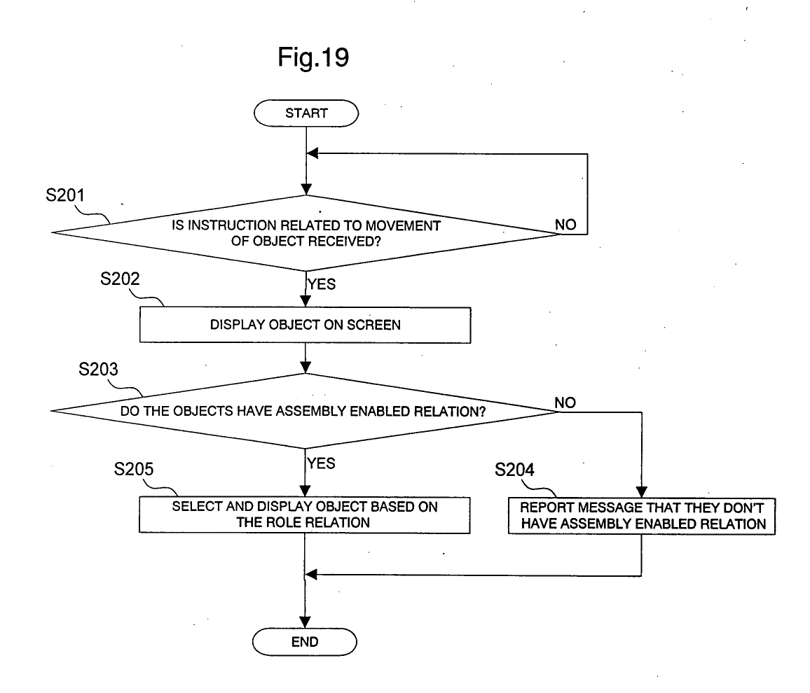

When the object movement instruction reception means 21 receives a movement instruction for assembling the one component object on the other component object (step S201), that is, when the object movement instruction reception means 21 receives an instruction relating to movement of an displayed object, as shown in FIG. 19 (step S201), first, the object display means 13 displays on screen the object at a place based on the instruction (step S202). Then, the assembly enabled relation determination means 18 determines whether or not the other object present at a place, where the aforesaid object is displayed, and the object thus displayed have assembly enabled relation, and when the above objects are determined not to have the assembly enabled relation (step S203), the first report means 19 or the second report means 20 reports that the above objects have not the assembly enabled relation (step S204). Meanwhile, when the above objects are determined to have the assembly enabled relation (step S203), the object selection means 12 selects and displays the object to be displayed, based on the role relation thereof (step S205).

(3) Flow related to the display of the selected object identification data, etc.

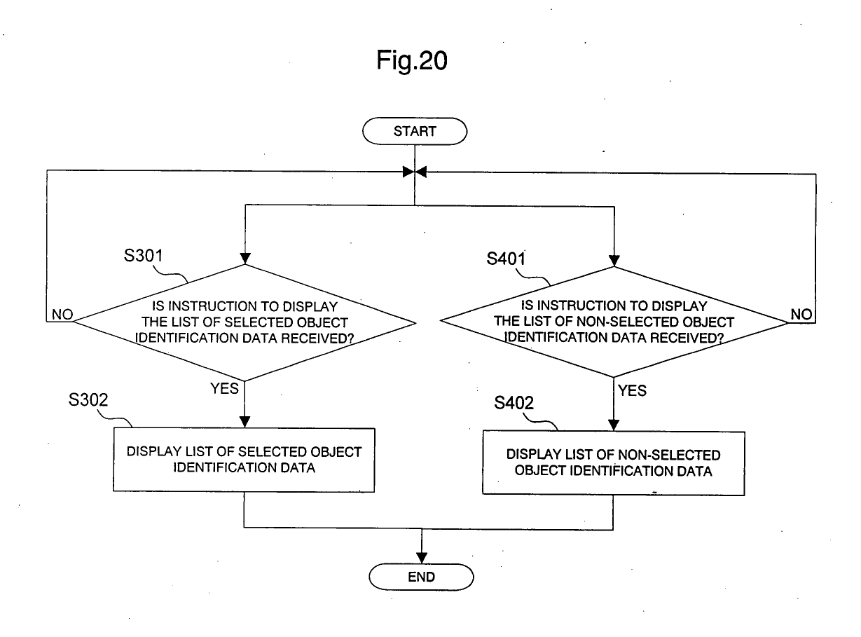

As shown in FIG. 20, when the instruction to display the list of the selected object identification data is received (step S301), the selected object identification data display means 15 displays the list of the selected object identification data (step S302). Also, similarly, when the instruction to display the list of the non-selected object identification data is received (step S401), the non-selected object identification data display means 16 displays the list of the non-selected object identification data (step S402).

(4) Flow related to the cooperation of the assembly procedure data and the space element data.

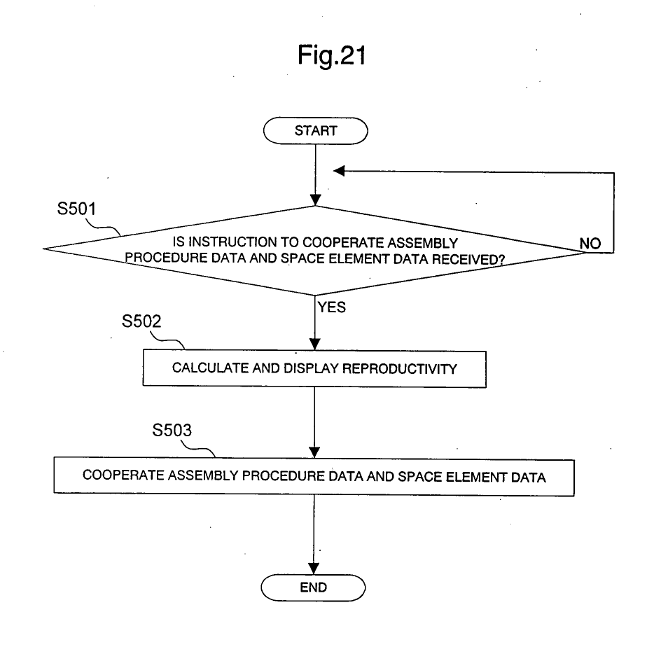

As shown in FIG. 21, when a command to cooperate the assembly procedure data and the space element data is received via the input interface 104, etc., (step S501), the reproductivity calculation display means 25 calculates the reproductivity and sort it into a prescribed order and display it, with reference to the metadata related to the space element data stored in the space element data storage means D2 and the metadata related to the assembly procedure data stored in the assembly procedure data storage means D1 (step S502). Then, based on a determination result received by the appropriateness determination result reception means 26, the cooperation management means 11 stores the aforementioned metadata in the cooperation management data storage means 24 by associating them with one another (step S503).

Note that the assembly procedure data used in calculation is not limited to the data stored in the assembly procedure data storage means D1, and for example, the assembly procedure data received by the assembly procedure data reception means 22 may be adopted.

(5) Flow of displaying an arbitrarily designated component object in the virtual space.

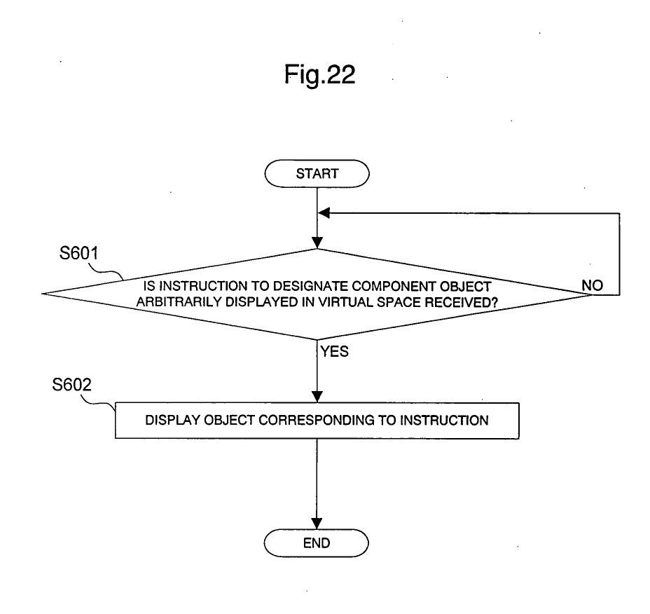

As shown in FIG. 22, when the display object designation instruction reception means 17 receives the instruction to designate the component object arbitrarily displayed in the virtual space (step S601), the object display means 13 displays the object corresponding to-the instruction received by the display object designation instruction reception means 17 (step S602)

This flow will be explained with a specific example. For example, the in-process product object displayed in the virtual space is assumed to include the bonnet object and the air cleaner object. At this time, a bonnet object OBa is selected by the object selection means 12 and is displayed in the virtual space. Meanwhile, an air cleaner object OBb is not selected by the object selection means 12 and is not displayed in the virtual space (see FIG. 14). Then, when the air cleaner object is selected out of the non-selected object identification data whose list is displayed by the non-selected object identification data display means 16, the display object designation instruction reception means 17 receives it as an instruction to designate the component object arbitrarily displayed in the virtual space (step S601), and the object display means 13 displays, as shown in FIG. 15, the air cleaner object OBb so as not to be concealed by the bonnet object OBa (step S602).

(6) Flow of displaying the component object in the virtual space by designating the display mode.

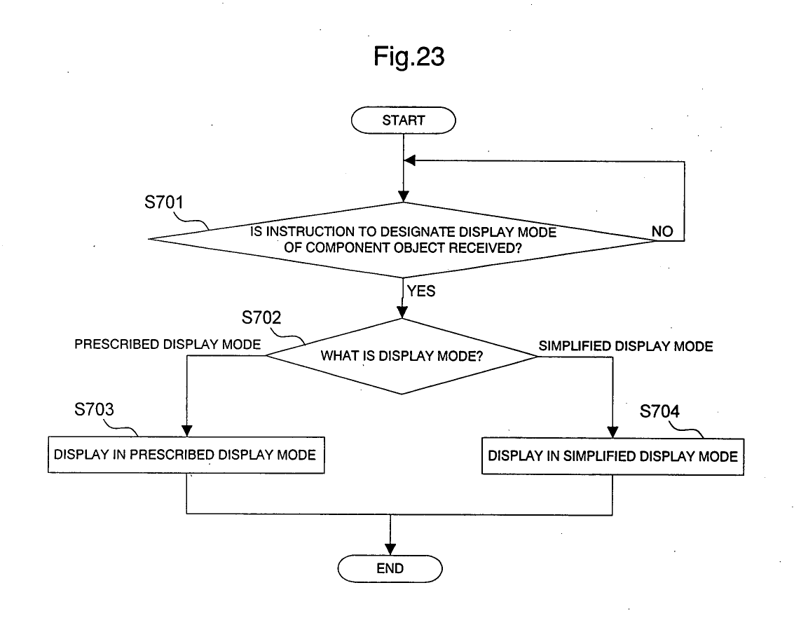

As shown in FIG. 23, when the display mode designation instruction reception means 14 receives the instruction to designate the display mode of the component object (step S701), then, based on the display mode designated by the display mode designation instruction thus received (step S702), the object display means 13 displays the component object (steps S703, S704).

As described above, according to the object display device P of the this embodiment, the object selection means 12 selects the component object to be displayed, based on the assembly procedure data showing the assembly procedure of the product. Therefore, without requiring the culling processing based on three-dimensional positional relation calculation required for performing a three-dimensional display of the component object as is conventionally done, an overlapped portion of the component objects is effectively processed as needed, and the in-process product object, etc., can be displayed at a high speed. In addition, without being affected by the shape of the object itself and the number of the objects to be displayed in the virtual space, a stable performance as a device can be secured. Particularly, by assembling a plurality of components, when the in-process product in a massive state (agglomerated state) housing a plurality of components is displayed as an in-process product object, the effect becomes remarkable. In addition, the assembly procedure data is set as a static data, and for example, if the setting is suitably changed, a desired component object can be easily displayed in the virtual space.

Namely, speeding-up of a drawing processing can be realized, and a stable performance can be exhibited as a device, and further the object display device P having high performance capable of easily displaying a desired object can be realized.

In addition, the assembly procedure data has the role relation data showing the role relation between the components, and therefore the role relation between the components in the real space can be effectively reflected on the role relation of the component object displayed in the virtual space. Accordingly, the real space and the virtual space can be suitably treated as an organically integrally connected one.

Moreover, when the role relation between one component and the other component is in a relation that the component of either one of the one component or the other component conceals a part or an entire part of the other component so as to be invisible from outside, with the one component and the other component assembled, data showing that either one of the one component or the other component conceals a part or an entire part of the other component is set in the role relation data related to the one component and the other component, whereby the object selection means 12 refers to the role relation data and selects the component object related to the component of covering side out of the one component and the other component. Therefore, while setting the role relation as a simple one, the object can be effectively selected.

In addition, the component object can be designated by the component object display data for displaying the component object in the virtual space, and by the component object identification data capable of identifying the component. Therefore, the component object identification data can be treated independently of the component object display data, while having a relation with the component object display data. Therefore, treatability of data is improved.

Then, the component object identification data has the metadata capable of imagining the component or a prescribed concept of the component. Therefore, the outline of the component object can be suitable grasped.

Moreover, there is provided the selected object identification data display means 15 for displaying the component object identification data related to the component object selected by the object selection means 12. Therefore, the component object selected by the object selection means 12 can be suitably grasped. Also, there is provided the non-selected object identification data display means 16 for displaying the component object identification data related to the component object not selected by the object selection means 12. Therefore, the component object not selected by the object selection means 12 can be suitably grasped.

There is provided the display object designation instruction reception means 17 for receiving the instruction for designating the component object arbitrarily displayed in the virtual space, and the object display means 13 displays the component object designated by the instruction received by the display object designation instruction reception means 17 together with the selected component object or replacing the selected component object. Therefore, an arbitrary object can be designated and displayed. This contributes to suitably grasping at which location of the in-process product in a prescribed in-process stage, components not assembled yet are attached, or at which place of the in-process product in a prescribed in-process stage, an already assembled object which is concealed by the other object is attached.

Moreover, the component object is displayed selectively in a prescribed display mode or in a simplified display mode which is more simplified than the prescribed display mode. In addition, the object display means 13 displays the component object selected by the object selection means 12 in the prescribed mode and displays the component object not selected by the object selection means 12 in the simplified display mode. Therefore, the component object not selected by the object selection means 12 can be suitably grasped in the virtual space.

Further, there is provided the display mode designation instruction reception means 14 for receiving the instruction to designate the display mode of the component object, and the object display means 13 can display the component object in the display mode designated by the instruction received by the display mode designation instruction reception means 14. Therefore, the component object can be displayed in a desired display mode out of the prescribed display mode and the simplified display mode.

It should be noted that the present invention is not limited to the embodiment as described above in detail.

For example, in this embodiment, the object display device P is constituted so as to treat a product object related to the product existing in the real space. However, the object display device P may be constituted so as to treat the object existing only in the virtual space. Specifically, with regard to the product object existing only in the virtual space and formed by assembling a plurality of component objects, by displaying the in-process product object in the in-process stage of the product object by using the component objects, the aforementioned similar examination is performed.

Then, specifically, based on the assembly procedure data showing the assembly procedure of the product object, the object display device P in this case may include the object selection means 12 for selecting the component object to be displayed in the virtual space out of the component objects constituting the in-process product object, and the object display means 13 for displaying the component object selected by the object selection means 12 in the virtual space as the selected component object.

Alternately, it may be so constituted that the component object data is communicated on a prescribed communication line, with the assembly procedure data accompanied therewith, and the object selection means 12 refers to the assembly procedure data thus accompanied with the component object display data, and selects an appropriate component object.

Although the object, etc., adopts either one of the mode, in which the joints are previously defined, or the mode in which the joints are not defined. However, when providing a joint adding means capable of dynamically adding the joint to the object, etc., in which the joints are not defined, operability can be improved.

Moreover, the assembly procedure data and the component object data may be cooperated using the component management number and the component object management number, without using the metadata.

### Second Embodiment

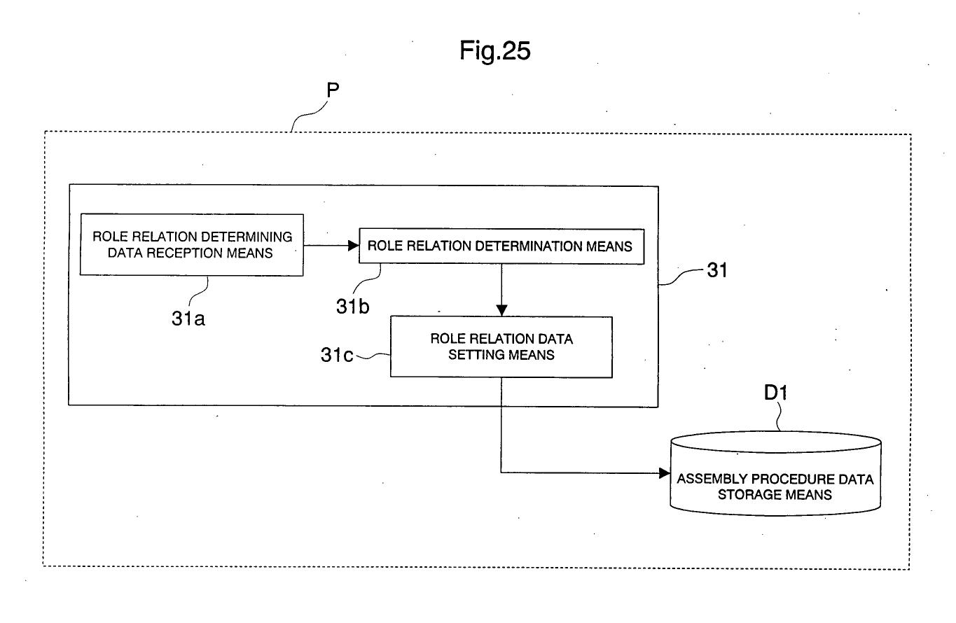

Hereafter, other embodiments of the present invention will be explained by using FIGS.25 to 28. Here, according to a second embodiment, in the flowchart showing an overall facility construction and an operation, parts indicated by the same signs and numerals as those of the first embodiment and not particularly explained, exhibit the same action effect as that of the first embodiment, and therefore an explanation is omitted.

The object display device P operates the CPU 101, etc., following an object display program stored in the internal memory 102, and as shown in FIG. 25, further exhibits the function as a role relation data setting support means 31, in addition to the function explained in the first embodiment.

The role relation data setting support means 31 urges the designation of a setting target component, which is a setting target of the role relation data, and determines whether or not the component object corresponding to the setting target component that receives designation, can be displayed on the component object corresponding to the other component, and based on a determination result thus obtained, supports so that the role relation data on the other component is automatically set in the setting target component, and has the function as a role relation determining data reception means 31a, a role relation determination means 31b, and a role relation data setting means 31c. Hereafter, each means will be described in detail.

The role relation determining data reception means 31a receives the designation of the setting target component, which is the setting target of the role relation data, and the designation of time for determining the role relation, as role relation determining data for determining the role relation of the setting target component at the designated time, wherein the input interface 104, etc., is used.

In this embodiment, the role relation determining data reception means 31a receives the setting target of the role relation data, i.e. “designation of the setting target component” by clicking with the mouse the component object management number whose list is displayed so that an input is urged. However, the embodiment is not limited thereto, and for example, the component object during display can also be received by mouse click.

Also, the role relation determining data reception means 31a receives “designation of time” for determining the role relation by an element work unit (final time in each element work), but the embodiment is not limited thereto, and it can also be received by step unit (final time in each step).

The role relation determination means 31b determines whether or not the setting target component has a role of covering side that covers the other component or the role of being covered by the other component at the time shown by the role relation determining-data received by the role relation determining data reception means 31a, by determining whether or not the display of the component object corresponding to the setting target component can be performed to the component object corresponding to the other component when the component object corresponding to the setting target component and the component object corresponding to the other component are displayed on screen.

Here, the other component used by the role relation determination means 31b for determination is selected to be the component excepting the setting target component, out of all components designated by the assembly procedure data corresponding to the time shown by the role relation determining data.

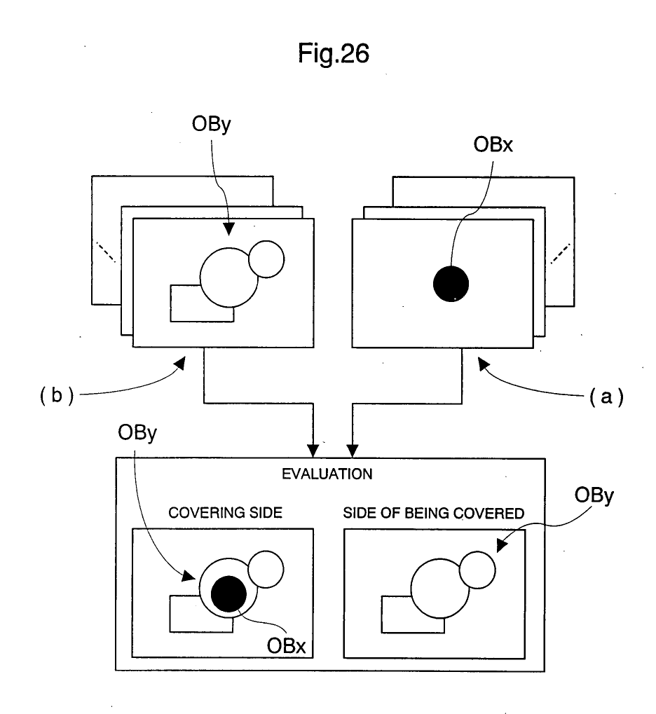

More specifically, a screen (see FIG. 26(a)) that displays a component object OBx corresponding to the setting target component and a screen (see FIG. 26(b)) that displays component objects OBy1 to OBy3 (referred to generally as OBy) are prepared. Then, when the component object OBx corresponding to the setting target component can be displayed to the component object OBy corresponding to the other component (see FIG. 26(c)) by using a Z buffer method, the setting target component is determined to be on the side of covering the other component. Meanwhile, when the component object OBx corresponding to the setting target component cannot be displayed to the component object OBy corresponding to the other component (see FIG. 26(d)), the setting target component is determined to be on the side of being covered. Note that the method is not limited to the Z buffer method, and a two-dimensional hidden surface removal processing method such as a scan line method and a ray-tracing method, and a three-dimensional space calculation processing method such as occlusion culling can also be used.

When the determination result of the role relation determination means 31b reveals that the setting target component is on the side of covering the other component, the role relation data setting means 31c sets the role relation data showing that the setting target component has the role of covering side that covers the other component, and when the role relation determination means 31b reveals that the setting target component is on the side of being covered by the other component, the role relation data setting means 31c sets the role relation data showing that the setting target component is on the side of being covered by the other component.

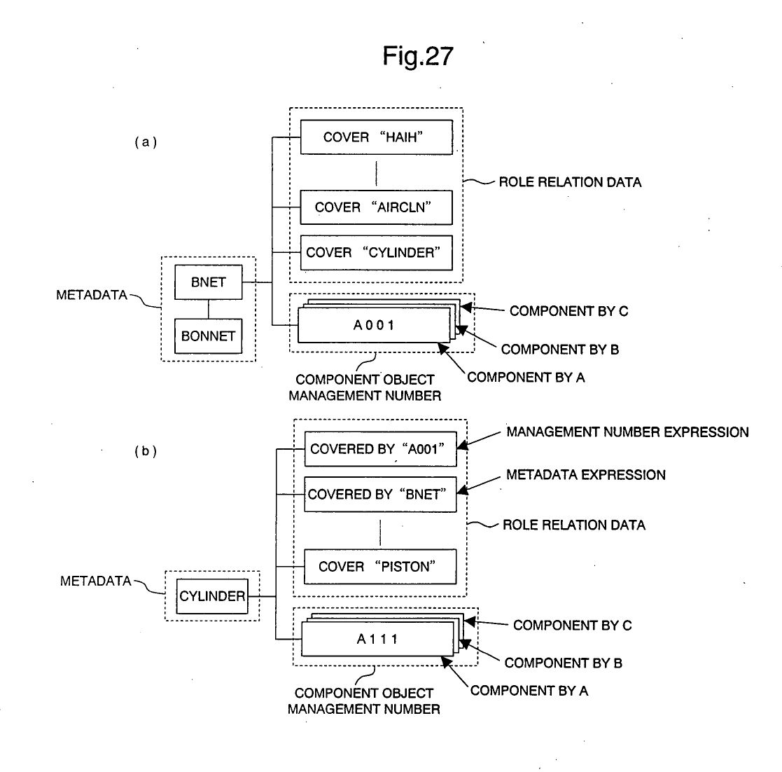

Then, the role relation data set by the role relation data setting means 31c is stored in the assembly procedure data storage means D1, so that the role relation data and the component object management number are associated with the metadata so as to form almost a tree structure, as shown in FIG. 27.

Note that a plurality of role relation data stored in the assembly procedure data storage means D1 can be stored in a state of being corresponded to the metadata (such as covering “cylinder” and covering “airCLN”), when it can be corresponded to the metadata, as shown in FIG. 27(a). The same thing can be said for the component object management number. Further, a plurality of metadata (such as Bnet, bonnet) can be stored.

The determination and setting as explained above are performed at all the time for setting the role relation data.

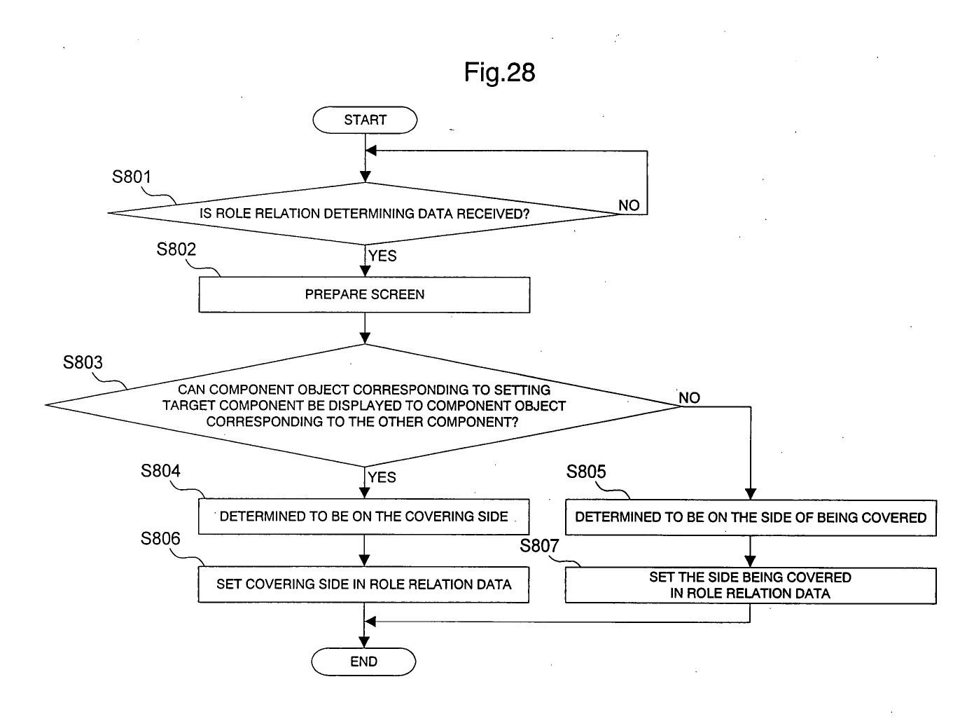

Next, the operation of the object display device P in this embodiment will be explained by using the flowchart shown in FIG. 28.

First, when the role relation determining data reception means 31a receives the designation of the setting target component, which is the setting target of the role relation data, and the designation of the time for determining the role relation as the role relation determining data (step S801), the role relation determination means 31b prepares the screen (see FIG. 26(a)) that displays the component object corresponding to the setting target component, and the screen (see FIG. 26(b)) that displays the component object corresponding to the other component at the time shown by the role relation determining data received by the role relation determining data reception means 31a (step S802). As shown in FIG. 26(c), by using the Z buffer method, when the component object corresponding to the setting target component can be displayed to the component object corresponding to the other component (step S803), the setting target component is determined to be on the side of covering the component (step S804) Meanwhile, as shown in FIG. 26(d), when the component object corresponding to the setting target component cannot be displayed to the component object corresponding to the other component (step S803), the setting target component is determined to be on the side of being covered by the other component (step S805).

Next, when the determination result of the role relation determination means 31b reveals that the setting target component is on the side of covering the other component, the role relation data setting means 31c sets the role relation data showing that the setting target component has the role of covering side that covers the other component (step S806), and when the determination result of the role relation determination means 31b reveals that the setting target component is on the side of being covered by the other component, the role relation data setting means 31c sets the role relation data showing that the setting target component is on the side of being covered by the other component (step S807).

In this way, the object display device P of this embodiment operates so that, only by having the role relation determining data reception means 31a receive, as the role relation determining data, the designation of the setting target component which is the setting target of the role relation data and the designation of the time for determining the role relation, the role relation determination means 31b determines the role relation of the setting target component to the other component, and the role relation data setting means 31c sets the role relation data based on the determination result by the role relation determination means 31b.

Namely, only by designating the role relation determining data, the role relation data of the component can be easily set.

Note that the present invention is not limited to the embodiment described above in detail.

For example, in this embodiment, the role relation data setting support means 31 supports the setting of role relation in the setting target component, so as to automatically set the role relation data on the other component. However, a manual setting may also be supported. In this case, the role relation data setting support means 31 may be so constituted that the designation of the setting target component, which is the setting target of the role relation data, is urged, and an operator determines whether or not the component object corresponding to the setting target component that receives the designation can be displayed to the component object corresponding to the other component, and the input of the role relation data based on the determination result of the operator is received.

In addition, the role relation data setting support means 31 may also include a common role relation calculation means (not shown) for obtaining a common role relation in each assembly procedure from the role relation obtained for every plural assembly procedures, by a calculating method such as an AND operation.

When there are a plurality of assembly procedures, the role relation determination means 31b may determine the role relation for each assembly procedure, the common role relation calculation means may obtain the common role relation from the role relation for each assembly procedure determined by the role relation determination means 31b, and the role relation data setting means 31c may set the common role relation obtained by the logic calculation means as the role relation data. According to this constitution, the role relation data plays a role as the common role relation in the related plurality of assembly procedures, and therefore an application range of the role relation data is enlarged, and thus the role relation data has more implication of a standard component.

As for the rest, a specific constitution of each part is not limited to the above-described embodiments, but can be variously deformed in a range not deviated from the gist of the present invention.

### INDUSTRIAL APPLICABILITY

As described above, according to the object display device of the present invention, the object selection means selects the component object to be displayed based on the assembly procedure data showing the assembling order of the product. Therefore, without requiring the culling processing based on three-dimensional positional relation calculation required for performing a three-dimensional display of the component object as is conventionally done, an overlapped portion of the component objects is effectively processed as needed, and the in-process product object, etc., can be displayed at a high speed. In addition, without being affected by the shape of the object itself and the number of the objects to be displayed in the virtual space, a stable performance as a device can be secured. Particularly, by assembling a plurality of components, when the in-process product in a massive state (agglomerated state) housing a plurality of components is displayed as an in-process product object, the effect becomes remarkable. In addition, the assembly procedure data is set as a static data, and for example, if the setting is suitably changed, a desired component object can be easily displayed in the virtual space.

Namely, high-speed drawing processing can be obtained, a stable performance as a device can be exerted, and further, an object display device having high performance capable of easily displaying a desired object can be provided.

1. An object display device, with regard to a product existing in a real space and being assembled by a plurality of components, capable of displaying the component as component object in a virtual space and of displaying an in-process product on an in-process stage of the product by using the component objects, the display device comprising:
object selection means for selecting a component object to be displayed in the virtual space out of the component objects constituting the in-process product object, based on assembly procedure data showing an assembly procedure of the product; and
object display means for displaying the component object selected by the object selection means as a selected component object.

2. The object display device according to claim 1, wherein the assembly procedure data has role relation data showing a role relation between the components.

3. The object display device according to claim 2, wherein when the role relation between one component and the other component is in a relation that one of the one component and the other component either partially or entirely conceals the other one of the components so as to be invisible from outside, with the one component and the other component are assembled, data showing that one of the one component and the other component either partially or entirely conceals the other one of the components so as to be invisible from outside is set in the role relation data related to the one component and the other component, whereby the object selection means is adapted to refer to the role relation data and to select the component object related to the component of covering side out of the one component and the other component.

4. The object display device according to claim 2, comprising role relation data setting support means that supports to urge designation of a setting target component which is a setting target of the role relation data, to determine whether or not the component object corresponding to the setting target component that receives the designation is displayable to the component object corresponding to the other component, and to set either manually or automatically the role relation data on the other component in the setting target component based on a determination result thus obtained.

5. The object display device according to claim 4, wherein
the role relation data setting support means comprises:
role relation determining data reception means for receiving the designation of the setting target component, which is the setting target of the role relation data, and the designation of time for determining the role relation, as role relation determining data for determining the role relation of the setting target component at the time thus designated;
role relation determination means for determining whether or not the setting target component has a role of covering the other component or being covered by the other component, by determining whether or not the display of the component object corresponding to the setting target component is performable to the component object corresponding to the other component when the component object corresponding to the setting target component and the component object corresponding to the other component are displayed on a screen; and
role relation data setting means for setting the role relation data showing that the setting target component has a role of covering side that covers the other component when a determination result reveals that the display of the component object corresponding to the setting target component is performable to the component object corresponding to the other component, and for setting the role relation data showing that the setting target component has a role of being covered by the other component when the display of the component object corresponding to the setting target component is not performable to the component object corresponding to the other component.

6. The object display device according to claim 5, wherein
the other component used for determination by the role relation determination means is the component excepting the setting target component, out of all components designated by assembly procedure data corresponding to time shown by the role relation determining data.

7. The object display device according to claim 6, wherein
the role relation data setting support means further comprises:
common role relation calculation means for obtaining a common role relation in each assembly procedure by a calculation method such as AND operation, from the role relation obtained for each assembly procedure, and
when there are plural assembly procedures,
the role relation determination means is adapted to determine the role relation for each assembly procedure;
the common role relation calculation means is adapted to obtain the common role relation from the role relation for each assembly procedure determined by the role relation determination means; and
the role relation data setting means is adapted to set the common role relation obtained by the logic calculation means as role relation data.

8. The object display device according to claim 1, wherein
the component object is allowed to be designated by component object display data for displaying the component object in the virtual space, as well as by component object identification data capable of identifying the component.

9. The object display device according to claim 8, wherein the component object identification data has metadata capable of reminding of the component or a prescribed concept regarding the component.

10. The object display device according to claim 9, wherein
the metadata is data obtained by generalizing a name of the component.

11. The object display device according to claim 8, comprising:
selected object identification data display means for displaying component object identification data related to the component object that has been selected by the object selection means.

12. The object display device according to claim 8, comprising:
non-selected object identification data display means for displaying the component object identification data related to the component object that has not been selected by the object selection means.

13. The object display device according to claim 8, wherein
the component object display data is allowed to be communicated on a prescribed communication line, with assembly procedure data accompanied therewith; and
the object selection means is adapted to select an appropriate component object by referring to the assembly procedure data accompanied with the component object display data.

14. The object display device according to claim 8, comprising:
cooperation management means for cooperatively managing the component object display data and the assembly procedure data, wherein
the object selection means is adapted to select the appropriate component object by referring to the assembly procedure data cooperatively managed by the cooperation management means.

15. The object display device according to claim 8, comprising:
display object designation instruction reception means for receiving an instruction for designating the component object arbitrarily displayed in the virtual space, wherein
the object display means is adapted to be capable of displaying the component object designated by the instruction received by the display object designation instruction reception means, together with the selected component object or replacing the selected component object.

16. The object display device according to claim 8, wherein
the component object is adapted to be able to display selectively in a prescribed display mode or a simplified display mode which is more simplified than the prescribed display mode; and
the object display means is adapted to be capable of displaying the component object that has been selected by the object selection means in the prescribed display mode, and the component object that has not been selected by the object selection means in the simplified display mode.

17. The object display device according to claim 16, comprising:
display mode designation instruction reception means for receiving an instruction to designate the display mode of the component object, wherein
the object display means is adapted to be capable of displaying the component object in the display mode designated by the instruction received by the display mode designation instruction reception means.

18. An object display device, with regard to a product object existing in a virtual space and being assembled by a plurality of component objects, capable of displaying an in-process product on in-process stage of the product object in the virtual space by using the component objects, the object display device comprising:
object selection means for selecting the component object to be displayed in the virtual space, out of the component objects constituting the in-process product object, based on assembly procedure data showing an assembly procedure of the product object; and
object display means for displaying the component object selected by the object selection means as a selected component object.

19. An object display program having a computer operate, with regard to a product existing in a real space and being assembled by a plurality of components, capable of displaying the component as component object in a virtual space and of displaying an in-process product on an in-process stage of the product by using the component objects, the program causing the computer to function as:
object selection means for selecting the component object to be displayed in the virtual space out of the component objects constituting the in-process object, based on assembly procedure data showing an assembly procedure of the product; and
object display means for displaying in the virtual space the component object selected by the object selection means as a selected component object.

20. An object display program having a computer operate, with regard to a product object existing in a virtual space and being assembled by a plurality of component objects, capable of displaying an in-process product object on an in-process stage of the product object by using the component objects, the program causing the computer to function as:
object selection means for selecting the component object to be displayed in the virtual space out of the component objects constituting the in-process object, based on assembly procedure data showing an assembly procedure of a product object; and
object display means for displaying the component object selected by the object selection means in the virtual space as a selected component object.
